(19) United States
(12) Patent Application Publication
(10) Pub. No.: US 2024/0386320 A1
(43) Pub. Date: Nov. 21, 2024

(54) Autonomous Optimization of Inkjet Printing Through Machine Learning

(71) Applicant: University of Connecticut, Farmington, CT (US)

(72) Inventors: Wing Kui Anson Ma, Tolland, CT (US); Qian Yang, Sturbridge, MA (US)

(73) Assignee: University of Connecticut, Farmington, CT (US)

(21) Appl. No.: 18/574,704

(22) PCT Filed: Jul. 1, 2022
(86) PCT No.: PCT/US2022/035952

§ 371 Date: Dec. 27, 2023

Related U.S. Application Data
(60) Provisional application No. 63/218,094, filed on Jul. 2, 2021.

(51) Int. Cl. G06N 20/00; B41J 2/01

(52) U.S. Cl. CPC G06N 20/00; B41J 2/01

(57) ABSTRACT

Active machine learning with model selection is used to control a printing system to efficiently, accurately, and autonomously predict jettability diagrams for different print head and ink combinations. A print system may be controlled using active machine learning to efficiently and accurately predict a jetting behavior for different combinations of ink and inkjet print heads at different settings/values for operating parameters of the print heads, such as firing voltage, pulse width/dwell time, frequency, ramp up, ramp down, meniscus pressure, heating rate, hold time, transducers' positions, geometries, and heating power, and/or other operating parameters of the print heads.

### RELATED APPLICATIONS

This application claims the benefit of and priority to U.S. Provisional Application No. 63/218,094, filed on Jul. 2, 2021, which is incorporated by reference herein in its entirety.

### STATEMENT OF GOVERNMENT SUPPORT

This invention was made with Government support under Grant No. 2020-67017-31273 awarded by the United States Depart of Agriculture, National Institute of Food and Agriculture. The Government has certain rights in the invention.

### BACKGROUND

Inkjet printing has evolved from a graphic and marking technology for two-dimensional (2D) patterning to enabling various three-dimensional 3D printing processes for electronics, optical, pharmaceutical, and biological applications (P. Calvert, Inkjet printing for materials and devices. Chem. mater. 13, 10 (2001) 3299-3305, doi.org/10.1021/cm0101632; J. Alamán, R. Alicante, J. I. Peña, C. Sánchez-Somolinos, Inkjet printing of functional materials for optical and photonic applications, Materials (Basel). 9 (2016), doi.org/10.3390/ma9110910; E. A. Clark, M. R. Alexander, D. J. Irvine, C. J. Roberts, M. J. Wallace, S. Sharpe, J. Yoo, R. J. M. Hague, C. J. Tuck, R. D. Wildman, 3D printing of tablets using inkjet with UV photoinitiation, Int. J. Pharm. 529 (2017) 523-530. doi.org/10.1016/j.ijpharm.2017.06.085; S. Y. Chang, S. W. Li, K. Kowsari, A. Shetty, L. Sorrells, K. Sen, K. Nagapudi, B. Chaudhuri, A. W. K. Ma, Binder-Jet 3D Printing of Indomethacin-laden Pharmaceutical Dosage Forms, J. Pharm. Sci. 109 (2020) 3054-3063, doi.org/10.1016/j.xphs.2020.06.027; Z. Zhang, Y. Jin, J. Yin, C. Xu, R. Xiong, K. Christensen, B. R. Ringeisen, D. B. Chrisey, Y. Huang, Evaluation of bioink printability for bioprinting applications, Appl. Phys. Rev. 5 (2018), doi.org/10.1063/1.5053979; C. M. B. Ho, S. H. N. Ng, K. H. H. Li, Y.-J. Yoon, 3D printed microfluidics for biological applications, Lab Chip. 15 (2015) 3627-3637; and L. Wang, M. Pumera, Recent advances of 3D printing in analytical chemistry: Focus on microfluidic, separation, and extraction devices, TrAC—Trends Anal. Chem. 135 (2021) 116151, doi.org/10.1016/j.trac.2020.116151). For these applications, a wide range of ink materials, ranging from polymer solutions and photocurable resins to colloidal dispersions and biomaterials, have been used (Y. Guo, H. S. Patanwala, B. Bognet, A. W. K. Ma, Inkjet and inkjet-based 3D printing: Connecting fluid properties and printing performance, Rapid Prototyp. J. 23 (2017) 562-576, doi.org/10.1108/RPJ-05-2016-0076; and I. M. Hutchings, G. D. Martin, eds. Inkjet technology for digital fabrication. Chichester, UK: Wiley, 2013).

Currently, cach new print system (printer/ink combination) requires calibration by trial and error, which is both time consuming and requires a considerable number of materials. Both the implementation of grid search and evaluation of jetting behavior at each print condition are currently implemented manually by an experimenter.

The success of printing these ink materials depends on whether these ink materials can be consistently and reliably jetted by the print systems. For piezoelectric print heads, in addition to the ink formulation which determines the fluid properties, the acoustics within the print head is equally important (Dijksman, J. Frits, ed. Design of Piezo Inkjet Print Heads: From Acoustics to Applications. John Wiley & Sons, 2019). While great progress has been made in predicting the jetting behavior of print heads using dimensionless groups that are largely based on measured fluid properties such as viscosity, surface tension, and density (Guo et al., 2017; Alamán et al., 2016; Chang et al., 2020; Zhang et al., 2018; Y. Liu, B. Derby, Experimental study of the parameters for stable drop-on-demand inkjet performance, Phys. Fluids. 31 (2019), doi.org/10.1063/1.5085868; and H. J. Lin, H. C. Wu, T. R. Shan, W. S. Hwang, The effects of operating parameters on micro-droplet formation in a piezoelectric inkjet printhead using a double pulse voltage pattern, Mater. Trans. 47 (2006) 375-382, doi.org/10.2320/matertrans.47.375), the acoustics associated with a specific print head is more challenging to predict as it further depends on the exact print head geometry and speed of sound through the ink, which may not be a parameter that is readily available. Further, with only a few exceptions (S. D. Hoath, D. C. Vadillo, O. G. Harlen, C. Mcllroy, N. F. Morrison, W.-K. Hsiao, T. R. Tuladhar, S. Jung, G. D. Martin, I. M. Hutchings Inkjet printing of weakly elastic polymer solutions, J. Non-Newton. Fluid Mech., 205, (2014), 1-10, doi.org/10.1016/j.jnnfm.2014.01.002; D. C. Vadillo, T. R. Tuladhar, A. C. Mulji, M. R. Mackley, The rheological characterization of linear viscoelasticity for ink jet fluids using piezo axial vibrator and torsion resonator rheometers, J. Rheol., 54, 4 (2010), 781-795, doi.org/10.1122/1.3439696; S. D. Hoath, J. R. Castrejón-Pita, W. K. Hsiao, S. Jung, G. D. Martin, I. M. Hutchings, T. R. Tuladhar, D. C. Vadillo, S. A. Butler, M. R. Mackley, C. Mellroy, Jetting of complex fluids. J. Imaging Sci. Technol., 57, 4, (2013), 40403-1, doi.org/10.2352/J.ImagingSci.Technol.2013.57.4.040403), most studies rely on rheological data that are collected from experiments with a characteristic frequency that is orders of magnitude lower and a residence time that is orders of magnitude larger than that which is typical of print systems. Results from such experiments may not be directly transferable to actual print processes (X. Wang, W. W. Carr, D. G. Bucknall, J. F. Morris, Drop-on-demand drop formation of colloidal suspensions, Int. J. Multiph. Flow, 38, 1 (2012), 17-26, doi.org/10.1016/j.ijmultiphaseflow.2011.09.001). Consequently, drop imaging experiments using actual combinations of ink and print heads of interest remain the most direct and reliable method for assessing the jetting performance for any new ink or new print head design. Based on images collected from drop imaging using high-speed or stroboscopic techniques, the jetting behavior of an ink from a print head can generally be classified as: “no jetting”, “jetting with primary drops only”, and “jetting with satellite drops” (Guo et al., 2017; Zhang et al., 2018; T. Jiao, Q. Lian, T. Zhao, and H. Wang, Influence of ink properties and voltage parameters on piezoelectric inkjet droplet formation, Appl. Phys. A,127, (2021), 1-9, doi.org/10.1007/s00339-020-04151-8). “Satellite drops” are smaller drops that are formed by the breakup of a ligament trailing a drop due to Plateau-Rayleigh instability (J. Eggers, Nonlinear dynamics and breakup of free-surface flows, Rev. Mod. Phys., 69, 3 (1997), 865, doi.org/10.1103/RevModPhys.69.865). Given that these smaller drops may not be generated consistently, and their precise deposition is difficult to control, satellite drops are generally deemed to be undesirable (Guo et al., 2017).

Due to the time, resource, and material cost, it is not desirable, and in some cases infeasible, to form jettability diagrams by collecting a full grid of experimental data points. The amount of time needed to complete grid search grows exponentially with the number of processing parameters of interest, which can include not only pulse width (dwell time) and voltage applied to the print heads, but also other controlled variables such as frequency, ramp up, ramp down, and meniscus pressure. When expensive and sensitive printing materials such as gold and biomaterials are used, minimizing the number of experiments for calibration is even more important.

Classification of jetting behavior based on experimental data and simulation results using machine learning approaches have been developed in recent years for various 3D printing technologies (H. Zhang, S. K. Moon, T. H. Ngo, Hybrid Machine Learning Method to Determine the Optimal Operating Process Window in Aerosol Jet 3D Printing, ACS Appl. Mater. Interfaces. 11 (2019) 17994-18003, doi.org/10.1021/acsami.9b02898; T. Wang, T. H. Kwok, C. Zhou, S. Vader, In-situ droplet inspection and closed-loop control system using machine learning for liquid metal jet printing, J. Manuf. Syst. 47 (2018) 83-92, doi.org/10.1016/j.jmsy.2018.04.003; Y. Zhu, Z. Wu, W. D. Hartley, J. M. Sietins, C. B. Williams, H. Z. Yu, Unraveling pore evolution in post-processing of binder jetting materials: X-ray computed tomography, computer vision, and machine learning, Addit. Manuf. 34 (2020) 101183. doi.org/10.1016/j.addma.2020.101183; J. Huang, L. J. Segura, T. Wang, G. Zhao, H. Sun, C. Zhou, Unsupervised learning for the droplet evolution prediction and process dynamics understanding in inkjet printing|Elsevier Enhanced Reader, Addit. Manuf. 35 (2020) 101197-101208. Zhang, H. and Moon, S. K., Reviews on machine learning approaches for process optimization in noncontact direct ink writing, ACS Applied Materials & Interfaces 13 (2021) 53323-53345, doi.org/10.1021/acsami.1c04544). These approaches have been successful in determining the relationship between processing parameters and jettability for a limited number of parameters, using typical sampling techniques that require a moderate to large number of experiments. For instance, Wang et. al. (2018), uses a recurrent neural network trained on video of the jetting process to predict and implement in-situ control of the jetting behavior in liquid metal jet printing (LMJP), where only one processing parameter, the voltage, is adjustable by the controller. In another study, Zhang et.al (2019) used classical clustering and classification algorithms to identify the operational zone in different processing conditions for aerosol jet printing (AJP), where transfer learning approaches were applied to reduce the number of experiments needed at different print speeds. However, the original classification still required Latin hypercube sampling of parameter space. Recently, Ruberu et al. (2021) used Bayesian optimization (BO) to efficiently find optimal printing parameters for 3D bioprinting with orders of magnitude fewer experiments than grid search. However, Bayesian optimization builds surrogate models that efficiently find optimal parameters, rather than efficiently building understanding of the full classification boundary between high-and poor-quality parameters. Additionally, this work does not address the challenges of model selection in the very small data case, which in practice typically requires techniques beyond the standard machinery of BO or default parameters. Finally, the assessment of the performance of various printing parameter combinations is manually conducted by the experimenter, rather than using an automated algorithm (Ruberu, K., Senadeera, M., Rana, S., Gupta, S., Chung, J., Yue, Z., Venkatesh, S., Wallace, G., Coupling machine learning with 3D bioprinting to fast track optimization of extrusion printing, Applied Materials Today 22 (2021) 100914, doi.org/10.1016/j.apmt.2020.100914).

### SUMMARY

Embodiments of the present disclosure use active machine learning with model selection to control a printing system to efficiently build accurate jettability diagrams. An important practical challenge for active learning is that model parameters are typically chosen a priori since model selection methods require additional data points to determine parameters. Embodiments of the present disclosure demonstrate the efficacy of using autonomous, closed-loop active learning with model selection to improve the accuracy of learned artificial intelligence models without increasing the number of required experiments.

Embodiments of the present disclosure are able to: (i) classify the jetting behavior of a given ink-print head combination efficiently for different operating parameters of the print head and compile the results into an operating diagram, termed a “jettability diagram,” that defines the different settings/values of the operating parameters to successfully jet the given ink from the print head, and (ii) use active learning in a fully automated loop with no human intervention, including during labeling of new datapoints, to reduce the number of experiments required for generating such jettability diagrams, resulting in savings including time, material, cost and resources. In practice, the jettability diagrams generated in accordance with embodiments of the present disclosure allow for the quick identification of the appropriate jetting condition(s) of a print head for any new inks of interest and fingerprint the jetting characteristics for a given pair of print head and ink. Such fingerprinting can be further used to detect any ink or print head changes over time for process monitoring, e.g., to monitor the health of print heads and/or to troubleshoot print head-related problems and/or to predict lifetime of the print head. For ink formulators, the jettability diagrams generated in accordance with embodiments of the present disclosure can be used to evaluate ink performance for designing more versatile inks for reliable jetting from a variety of print heads and for different print conditions.

In accordance with embodiments of the present disclosure systems, methods, and non-transitory computer-readable media for predicting jettability of a print head and ink combinations are disclosed. A print head is controlled to eject ink by a processing device and an imaging device is configured to capture images of jetting behavior of the print head and ink combination. The processor is programmed to generate, for a set of default hyperparameter values, a classification model using active learning. The classification model is autonomously generated without human intervention using closed-loop automation by iteratively determining a decision boundary predicting the jetting behavior of a print head and ink combination based on training data corresponding to labeled data points, and identifying the next most informative data point to label from a pool of unlabeled data points, until an active learning labeling budget is depleted. The data points correspond to operating parameter values of the print head. The processor is also programmed to generate and evaluate the performance of a plurality of new classification models for different sets of hyperparameter values including the default classification model using, for example, cross-validation, such as k-fold or leave-one-out cross-validation (LOOCV), select a highest performing classification model from the default classification model or one of the plurality of new classification models corresponding to one of the sets of hyperparameter values based on the evaluated performance, re-train the selected highest performing classification model using the corresponding one of the sets of hyperparameter values and the set of labeled data points, and output a jettability diagram predicting the jetting behavior of the print head and ink combination for a range of operating parameter values of the print head based on the re-trained selected highest performing classification model. The process can be repeated for different print heads and inks to autonomous predict jettability of the different print head and ink combinations.

Any combination or permutation of features, functions and/or embodiments as disclosed herein is envisioned. Additional advantageous features, functions and applications of the disclosed systems, methods and assemblies of the present disclosure will be apparent from the description which follows, particularly when read in conjunction with the appended figures. All references listed in this disclosure are hereby incorporated by reference in their entireties.

### BRIEF DESCRIPTION OF THE FIGURES

Illustrative embodiments are shown by way of example in the accompanying drawings and should not be considered as a limitation of the present disclosure.

FIG. 1 is a block diagram illustrating a printing system to train and test an artificial intelligence model and predict jetting behavior of ink-print head combinations in accordance with embodiments of the present disclosure.

FIG. 2 is a block diagram illustrating an example printer in accordance with embodiments of the present disclosure.

FIG. 3 is a block diagram of a computing device in accordance with embodiments of the present disclosure.

FIG. 4 illustrates an iterative process for defining a decision boundary using active learning with an RBF kernel SVM algorithm in accordance with embodiments of the present disclosure.

FIG. 5A is a flowchart illustrating a first part of an example process to determine a jettability zone for a print head and ink combination using different operating parameters in accordance with embodiments of the present disclosure.

FIG. 5B is a flowchart illustrating a second part of an example process to determine a consistent jetting zone for a print head and ink combination in accordance with embodiments of the present disclosure.

FIG. 6 is a graph that illustrates an example process of selecting an unlabeled data point to be labeled to iteratively and autonomously determine the decision boundary of an RBF kernel SVM model in accordance with embodiments of the present disclosure.

FIG. 7 illustrates an example for generating a predicted jettability diagram based on physical simulations in accordance with embodiments of the present disclosure.

FIGS. 8A-D illustrate example data points in a jettability diagrams as a function of fluid properties based on theoretical calculations in accordance with embodiments of the present disclosure.

FIG. 9 illustrates an example system for imaging the output of a print head to determine a jettability behavior of the print head in accordance with embodiments of the present disclosure.

FIG. 10 illustrates an example waveform corresponding to operating parameters of a print head in accordance with embodiments of the present disclosure.

FIG. 11A-D show some representative images collected using the drop watching system in accordance with embodiments of the present disclosure.

FIG. 12A illustrates an observed jetting behavior of a print head at different firing voltages and pulse widths for degassed water in accordance with embodiments of the present disclosure.

FIG. 12B illustrates an observed jetting behavior of a print head at different firing voltages and pulse widths for a model fluid in accordance with embodiments of the present disclosure.

FIG. 13 is an example of a confusion matrix in accordance with embodiments of the present disclosure.

FIG. 14A shows a validation accuracy heat map in a model selection process in accordance with embodiments of the present disclosure.

FIG. 14B shows a decision boundary using fixed model as the final best model in accordance with embodiments of the present disclosure.

FIG. 14C shows a decision boundary using a model derived via a model selection method as the final best model in accordance with embodiments of the present disclosure.

FIGS. 15A-D show final models using thirty experimental sampled data points on degassed water and model fluid in accordance with embodiments of the present disclosure.

FIGS. 16A-B show the accuracy of the final model on experimental test data for degassed water and model fluid, respectively, in accordance with embodiments of the present disclosure.

FIGS. 17A-D show jettability diagrams and underlying data points for data sampled using active learning and a grid search in accordance with embodiments of the present disclosure.

### DETAILED DESCRIPTION

Embodiments control an operation of a print system using active machine learning to efficiently and accurately predict a jetting behavior for different combinations of ink and inkjet print heads at different settings/values for operating parameters of the print heads, such as firing voltage, pulse width (dwell time), frequency, ramp up, ramp down, meniscus pressure, heating rate, hold time, transducers' positions, geometries, and heating power, and/or other operating parameters of the print heads. The operating parameters described herein for print heads can depend on a type of print head being employed. As an example, for a piezoelectric print head, the operating parameters can include, but are not limited to, firing voltage, pulse width, frequency, and meniscus pressure. As another example, for a bubble jet print head, the printability parameters may include, but are not limited to, heating rate, hold time, and heating power. Additionally, the print head design may include placement of piezoelectric/heating element(s), nozzle size, internal geometry, and the like. Any reference to particular operating parameters or combinations of operating parameters are examples illustrating an implementation of embodiments of the present disclosure, and embodiments of the present disclosure can control any of the operating parameters of the print heads independently or in any combination with other operating parameters of the print heads.

Embodiments of the present disclosure classify jetting behavior of an ink-print head combinations based on collected images of printing experiments, which are autonomously selected using predictive outputs from machine learning models. For example, embodiments of the present disclosure employ an active learning method using support vector machines (SVM) coupled with model selection to iteratively select settings/values for operating parameters of a print head, execute a printing experiment based on the settings/values for the operating parameters, use the resulting labels from the printing experiment as a new input for training the SVM for a next iteration, and generate a jettability diagram after the SVM is trained. By using active machine learning to determine and implement the next print conditions of printing experiments, the jettability diagrams can be generated with as few experiments as possible. The efficient sampling of settings/values for the operating parameters based on simultaneous model selection and active learning of the systems, methods, and computer-readable media described herein leads to prediction of an accurate jetting zone for different print head and ink combinations.

Embodiments of the present disclosure classify printing/jetting behavior in two binary classification steps in sequence. First, a decision boundary between “jetting” and “no jetting” zones is identified using active learning to reduce the number of printing experiments required to generate the decision boundary. Then, based on the labeled data, another round of active learning is executed to find a “consistent jetting” zone (defined by the setting/values for operating parameters of the print head) for a given ink and print head combination. Experimental results obtained from active learning process of the present disclosure were compared to a conventional grid search method, which involves running more than two hundred (200) experiments for each fluid, to assess the performance of the proposed scheme, and embodiments of the present disclosure significantly reduced the number of printing experiments required to define a decision boundary by 80% while achieving a precision of more than 95% in “jetting” zone prediction.

A database of jettability diagrams can be created based on the printing experiments for the different ink-print head combinations. Improved accuracy of the machine learning models in predicting printability of a new ink and print head combination can be achieved as more jettability data is included in the database.

As used herein, “a”, “an”, and “the” refer to both singular and plural referents unless the context clearly dictates otherwise.

As used herein, the terms “comprise(s)”, “comprising”, and the like, specify the presence of stated features, integers, steps, operations, elements, and/or components, but do not preclude the presence or addition of one or more other features, integers, steps, operations, elements, components, and/or groups thereof.

As used herein, the terms “configure(s)”, “configuring”, and the like, refer to the capability of a component and/or assembly, but do not preclude the presence or addition of other capabilities, features, components, elements, operations, and any combinations thereof.

All ranges disclosed herein are inclusive of the endpoints, and the endpoints are independently combinable with each other. Each range disclosed herein constitutes a disclosure of any point or sub-range lying within the disclosed range.

All methods described herein can be performed in any suitable order unless otherwise indicated herein or otherwise clearly contradicted by context. The use of any and all examples, or exemplary language (e.g., “such as”), is intended merely to better illustrate the invention and does not pose a limitation on the scope of the invention or any embodiments unless otherwise claimed.

As used herein, “jet” or “jetting” refers to the expelling or ejecting of ink from a print head (e.g., via nozzles of the print head).

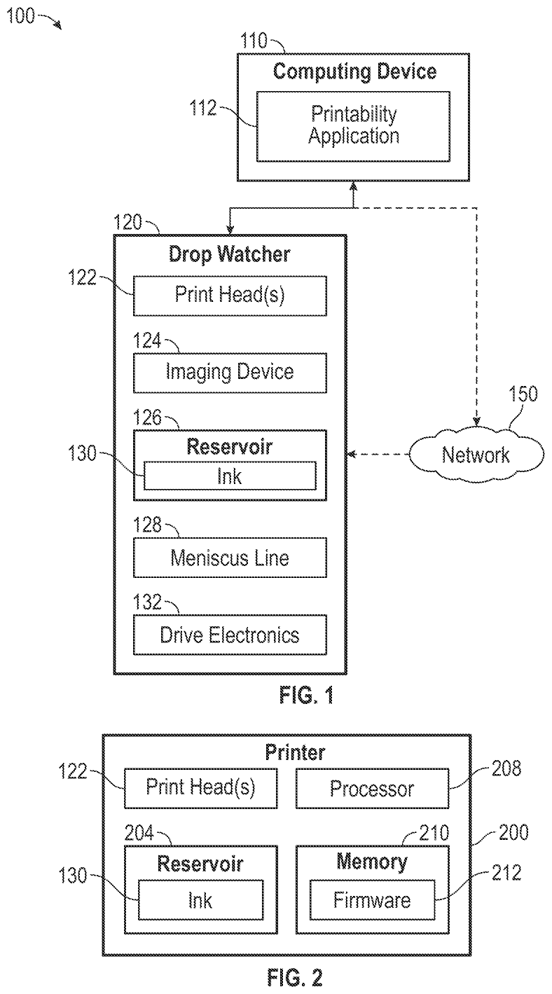

FIG. 1 is a block diagram illustrating a printing system 100 to train and test an artificial intelligence model and predict jetting behavior of ink-print head combinations in accordance with embodiments of the present disclosure. The printing system 100 can include a computing device 110 and a drop watching system 120. The computing system can be in wired or wireless communication with the drop watching system 120 directly or indirectly through via one or more intervening device (e.g., devices in a network 150, such as servers, routers, switches, etc.). The drop watcher setup 120 includes a print head under test 122, an imaging device (e.g., a camera) 124, an ink reservoir 126, and a meniscus line 128. The ink 130 is loaded into the ink reservoir 126 and may or may not be circulated between the reservoir 126 and print head 122. For piezoelectric print heads, the computing device 110 controls jetting of the ink 130 from nozzles of the print head 122 by sending an electrical signal, or waveform, to the print head 122 via drive electronics 132.

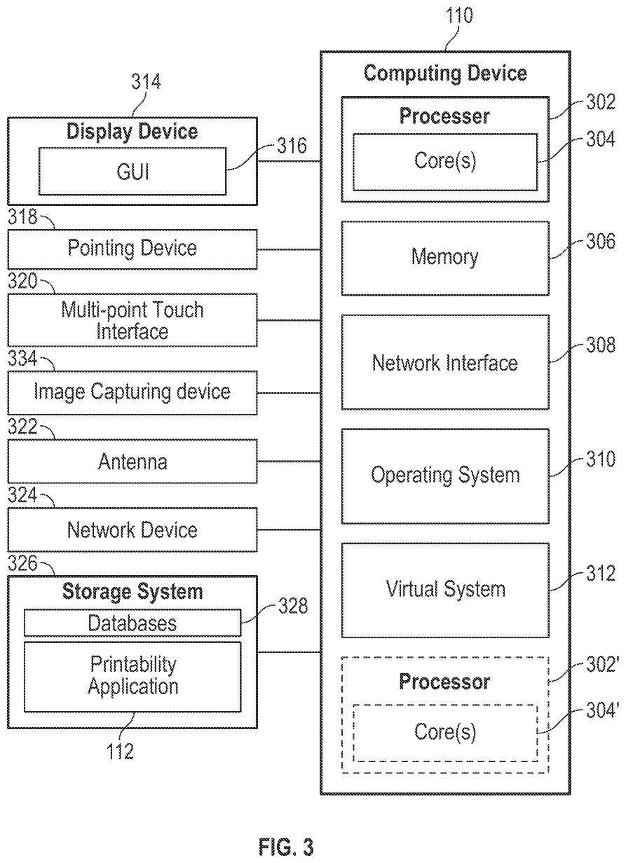

The computing device 110 can be programmed to include a printability application 112 executing one or more machine learning algorithms to autonomously determine jetting zones for ink-print head combinations and generate predicted jettability diagrams for different combinations of print heads and inks at different settings/values for operating parameters of the print heads as described herein. The computing device 110 executes the printability application 112 in a fully automated loop without human intervention, including during labeling of new data points, to reduce the number of experiments required to predict jetting behavior of print head and ink combinations. The ink 130 is fed to and jetted by nozzles of the print head 122 in response to instructions received from the computing device 110, which can specify settings/values for the operating parameters of the print head 122, such as a firing voltage applied to the print heads 122, a pulse width, or dwell time, of the firing voltage applied to the print heads, frequency, ramp up, ramp down, meniscus pressure, heating rate, hold time, and/or heating power. For example, a processor 302 (shown in FIG. 3) of the computing device 110 transmits instructions to the drive electronics 132, which are received and processed by drive electronics 132. In response to the instructions, the drive electronics 132 control an operation and operating parameters of the print head 122. The computing device 110 and the drop watching system 120 can be stand-alone systems and/or can be integrated in accordance with embodiments of the present disclosure. The imaging device 124 of the drop watching system captures images of outputs of the print head 122, which can be used by the computing device 110 executing the printability application to determine whether the print head 122 jetted the ink 130 in response to the instructions sent by the computing device 110 and received by the drive electronics 132. The imaging device 124 of the drop watching system 120 can be disposed in proximity to the output of the print head 122 and/or can use high-speed or stroboscopic imaging to capture the images of the output of the print head 122.

In example embodiments, the images captured by the drop watching system 120 can be processed using machine vision algorithms (e.g., convolutional neural networks) and techniques to automatically classify the jetting behavior. The computing device 110 uses the output of the machine vision algorithm(s) to assign labels (e.g., jetting, no jetting) to the data points (e.g., settings/values of two or more operating parameters of the print head). The machine vision algorithms and techniques can include, for example, Stitching/Registration, Filtering, Thresholding, Pixel counting, Segmentation, Inpainting, Edge detection, Color Analysis, Blob discovery and manipulation, Neural net processing, deep learning, Pattern recognition, object recognition, blurring, normalized lighting, grey-scaling, OTSU, thresholding, erosion/dilation, convert correct hull, contour detection, blob/mass calculation normalization, and/or Gauging/Metrology to recognize and measure ink in a scene imaged by the imaging device 124 of the drop watcher 120, such as, for example, non-jetted, partially jetted, consistently jetted, and inconsistently jetted.

The printability application 112 executed by the computing device 110 can use active learning to efficiently choose the next printing experiment to implement for labeling the next data point (as the output of the print head 122 in response to the printing experiments) to optimize performance of the machine learning model. The computing device 110 can execute the printability application 112 to first determine the boundary between the “jetting” and “no jetting” zones, and then to find the “consistent jetting” zone from within the jetting zone. The use of active learning by the printability application 112 is beneficial where obtaining labeled data points is (computationally or resource) expensive, but unlabeled data points are abundant. The active learning approach is also advantageous when there are many tunable operating parameters (“the curse of dimensionality”). The computing device 110 executes the printability application to classify printing/jetting behavior in two binary classification steps in sequence. First, the printability application 112 is executed by the computing device 110 to determine a decision boundary between “jetting” and “no-jetting” zones using active learning to reduce the number of printing experiments required to generate the decision boundary. Then, based on the labeled data, the computing device 110 executes the printability application 112 to perform another round of active learning to find a “consistent jetting” zone for a given ink and print head combination, where a consistent jetting zone corresponds to values/settings for the operating parameters of the print head that result in consistent desired jetting behavior and excludes values/settings for the operating parameters that result in a no-jetting zone which covers no-jetting and partial jetting.

To facilitate active learning, the printability application 112 uses soft margin support vector machines (SVM) with radial basis function (RBF) kernel to build a binary classifier for non-linear jettability zones. SVMs are a supervised learning method that find a hyperplane (decision boundary) between different classes that maximizes the distance of data points in each class from the decision boundary. This maximum distance is referred to as a margin of separation. In soft margin SVM, some data points are allowed to be less than the margin of separation away from the decision boundary to allow a larger margin of separation.

Consider a set of n data points is denoted by xᵢ∈R^{d}(i=1, . . . , n) with corresponding labels of yᵢ∈{0,1}(i=1, . . . , n) where the label of each data point represents specific class. For example, for a set of values/settings for a pulse width and firing voltage of a print head, there is a specific label of either jetting or no-jetting that can be applied based on an output of the print head (e.g., detected jetting of ink by the drop watcher or a failure to detecting jetting of ink by the drop watcher). To train a SVM, the following optimization problem is solved:

$${min}_{ω , b , ξ} \frac{1}{2} {ω}^{T} ω + C {\sum }_{i = 1}^{n} {ξ}_{i}$$

$$subject to {y}_{i} ( {ω}^{T} ϕ ( {x}_{i} ) + b ) \geq 1 - {ξ}_{i}$$

$${ξ}_{i} \geq 0 , i = 1 , … , n$$

The regularization parameter, C, is a hyperparameter that controls a trade-off between minimizing errors (misclassified points and those less than the margin of separation away from the decision boundary) and maximizing the margin. A soft margin SVM algorithm with a radial basis function (RBF) kernel enables non-linear decision boundaries. The RBF kernel is given by

$$K ( {x}_{i} , {x}_{j} ) = exp ( - γ {‖ {x}_{i} - {x}_{j} ‖}^{2} ) = 〈 ϕ ( {x}_{i} ) , ϕ ( {x}_{j} ) 〉$$

The gamma parameter, γ, is a hyperparameter of the RBF kernel that controls the radius of influence of each training data point on the model prediction. The larger the gamma parameter, γ, the smaller the spread of the RBF kernel, which leads to more complex decision boundaries that tend to circle around data points. The RBF kernel SVM algorithm of the printability application 112 is executed by the computing device 110 to find the decision boundary for a binary classification problem and predict the label for each data points of, e.g., {x₁, x₂}={pulse width, firing voltage}, after training on a dataset with known labels (training set). The RBF kernel SVM algorithm takes as input two or more features, in this example pulse width and firing voltage, and predicts the results of a printing experiment using the two or more features. For example, two features: pulse width and firing voltage, can be specified in response to execution of the printability application 112 and the RBF kernel SVM algorithm predicts the label (jettability) to associate with the data point for the two features. The training data used to train RBF kernel SVM algorithm of the printing application includes two features: pulse width and firing voltage, and corresponding labels (e.g., jetting and no jetting). In traditional supervised learning, a training dataset consisting of data points sampled IID (independently identically distributed) from the population would first be obtained. The training dataset to train the RBF kernel SVM algorithm includes data points sampled IID from a grid of feasible combinations of settings/values of two or more operating parameters (e.g., firing voltage and pulse width) for a given print head.

The printability application 112 executed by the computing device 110 can use pool-based active learning for the RBF kernel SVM algorithm. In pool-based active learning, there is a fixed pool of unlabeled data points from which the computing device 110 executing the printability application 112 can choose to acquire a next label. Choosing which data point to label is decided by an acquisition function of the printability application 112 executed by the computing device 110. The printability application 112 uses active learning strategies for the acquisition function. As an example, the printability application 112 can use uncertainty sampling for the acquisition function, in which the computing device 110 executes the RBF kernel SVM algorithm of the printability application 112 to acquire information about data points it is most uncertain about, for some measure of uncertainty. The computing device 110 executing the printability application 112 can use uncertainty sampling to choose a data point closest to the current decision boundary or hyperplane of the RBF kernel SVM algorithm.

The active learning algorithm (e.g., RBF kernel SVM algorithm) of the printability application 112 is initialized with an initial sample of labeled data points. Effective initialization of active learning is a practical challenge. An overall data budget for training a model with the RBF kernel SVM algorithm of the printability application 112 is very small, thus an initial sample of labeled data points can include, for example, four labeled points. To maximize the effectiveness of the initial sample of labeled data points, data points are chosen in regions of high and low voltage, due to a priori knowledge that the decision boundary between the jettable and non-jettable regions is likely to span across the middle range of voltages. This ensures that the initial sample is likely to contain both classes (jettable and non-jettable); if not, sampling of these regions can continue until data points in both classes (jettable and non-jettable) are found. After samples from both classes are identified, the computing device 110 can execute the printability application 112 to iteratively and autonomously choose the next data point (i.e., a next setting/value for two or more operating parameters, such as firing voltage and pulse width) from a pool of unlabeled data points based on the highest uncertainty on the predicted label, e.g., the data point with shortest distance to the decision boundary. This data point is the new query for which the computing device 110 instructs the print head 122 to output a printing experiment from which a label is acquired based on the image captured by the imaging device 124 of the drop watcher 120. After the new data point is labeled, the new data point is added to the training dataset. This process continues until the labeling budget is exhausted.

As described herein, RBF kernel SVM algorithm of the printability application 112 requires that two hyperparameters: a regularization parameter, C, and a gamma parameter, γ, be specified. An appropriate choice of regularization parameter, C, and gamma parameter, γ, is needed to optimize the bias-variance tradeoff of the model and ensure good predictive performance once the model is deployed. In batch supervised learning, where all training data are available at the start of training, the optimal choice of regularization parameter, C, and gamma parameter, γ, is selected in a model selection process, most commonly using validation data. The overall dataset is partitioned into training, validation, and test data. After training the model on training data using different sets of parameters, the set of parameters that result in the optimal performance of the corresponding trained model on the validation data is chosen. The final model using these optimal parameters is trained by combining training and validation data, and its expected performance is estimated using test data. In the present disclosure, data is scarce, and k-fold cross-validation can be used, whereby the data is partitioned into k folds, and k models are trained using k−1 folds for training and 1-fold for validation. In the limit of very small datasets described herein, k=N, the total number of data points is used. This is called leave-one-out cross-validation (LOOCV).

In active learning, it is difficult to incorporate model selection because the next data point (e.g., the settings/values of two or more of the operating parameters) to query requires use of a particular regularization parameter, C, and gamma parameter, γ, and a sufficiently large validation dataset is not generally feasible in the small-data settings that active learning is used in. This is a significant drawback of active learning in practice, since the quality of the final learned model can vary a lot depending on the regularization parameter, C, and gamma parameter, γ, chosen.

To address this challenge, embodiments of the printability application 112 can use Practical Active Learning with Model Selection (PALMS) described in “Practical Active Learning with Model Selection for Small Data,” by Pardakhti et al., 2021 20th IEEE International Conference on Machine Learning and Applications (ICMLA), which is incorporated by reference herein in its entirety. In the PALMS algorithm, active learning is first used with a fixed choice of the regularization parameter, C, and the gamma parameter, γ. Then, after the biased labeled dataset is obtained, a final model selection step using LOOCV is implemented to choose the regularization parameter, C, and the gamma parameter, γ, with which to re-train the model, which leads to better performance than active learning without model selection.

As a non-limiting example, the computing device 110 can execute the printability application 112 using the following ranges for the regularization parameter, C, and the gamma parameter, γ, for 20 models overall:

$$C = [ 0.01 , 1 , 100 , 10000 ]$$

$$Gamma = {γ}_{auto} \times [ 0.0001 , 0.01 , 1 , 100 , 10000 ] = \frac{1}{n} [ 0.0001 , 0.01 , 1 , 100 , 10000 ]$$

where n is number of features (here n=2).

As described herein, the execution of the printability application 112 can include two parts. The first part can be executed to generate a prediction of a “jetting” versus “no jetting” zone. The second part can be executed to generate a prediction of “consistent jetting” zone versus “others” zone, where the “others” zones include, e.g., no jetting, partial jetting, and inconsistent jetting.

The first part of the printability application 112 works as follows: an initial sample of data points (e.g., four data points) is randomly selected from a pool of unlabeled data points. The labels for the initial sample are collected and evaluated. The printability application 112 requires labeled data to be in two classes: “no jetting” (Class 0) and “jetting” (Class 1), which is determined based on images of the jetting output from the print head captured by the drop watching system 120 for the data points (pulse width, firing voltage settings/values) in the initial sample. If only one of the classes is observed, the computing device continues to execute the first part of the printability application 112 to continue labeling beyond the initial sample until two classes are observed or until a labeling budget is reached.

As soon as two classes of “no jetting” and “jetting” are observed, the RBF kernel SVM model is implemented on the two-class labeled sample by the computing device 110 to find the decision boundary between “jetting” and “no jetting”. The computing device 110 executes the RBF kernel SVM model of the printability application to find a next data point (i.e., settings/values of two more operating parameters of the print head) that is closest to the decision boundary from the pool of unlabeled data points. The computing device 110 controls the print head 122 to attempt to jet the ink using the settings/values of the operating parameters of the next data point and labels the next data point based on an observed jetting or non-jetting of ink from the print head. This newly labeled data point is added to the training data and the computing device executes the printability application 112 to re-train the RBF kernel SVM model to find the new trained model and a new decision boundary. This iterative learning loop can continue until the labeling budget is finished. A range of RBF kernel SVM models is then trained from the labeled data. The performance of cach RBF kernel SVM model is evaluated based on an appropriate performance metric such as accuracy or F₁ score and the best performing model is selected by the computing device 110 and trained on all labeled data and then is implemented to predict labels of data points in the pool. This model is the final model reported to the user that shows the “no jetting” vs. “jetting” zone.

Upon completion of the first part of the printability application 112, the computing device 110 can execute the second part of the printability application 112 to distinguish between a consistent jetting zone from other zones. For execution of the second part of the printability application, the labeled data points are relabeled to reflect Class 0 as “others” and Class 1 as “consistent jetting”. With two classes, active learning (with RBF kernel SVM using default parameters) performs an identical iterative learning loop as the first part. In a final step, performance of the range of models on all labeled data is determined and the best performing model for “consistent jetting” zone prediction is selected, trained on all labeled data, and implemented to predict labels of data points in the pool.

FIG. 2 is a block diagram of an example printer 200 in accordance with embodiments of the present disclosure. The printer can include the print head(s) 122, an ink reservoir 204 (or reservoir 126) storing the ink 130, a processor 208, and memory 212. The printer 200 is configured based on the output of the printability application 112 so that the print head(s) 122 operate in the consistent jetting zone. As an example, firmware 212 stored in the memory can be executed by the processor 208 to control an operation of the print head 122 using operating parameters that are predicted to be within the “consistent jetting” zone.

FIG. 3 is a block diagram of an example computing device 110 for implementing exemplary embodiments of the one or more servers described herein. The computing device 110 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 306 included in the computing device 110 may store computer-readable and computer-executable instructions or software (e.g., printability application 112) for implementing exemplary operations of the computing device 110. The computing device 110 also includes configurable and/or programmable processor 302 and associated core(s) 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for implementing exemplary embodiments of the present disclosure. Processor 302 and processor(s) 302′ may each be a central processing unit (CPU) or graphical processing unit (GPU) have a single core processor or multiple core (304 and 304′) processor. Either or both of processor 302 and processor(s) 302′ may be configured to execute one or more of the instructions described in connection with computing device 110.

Virtualization may be employed in the computing device 110 so that infrastructure and resources in the computing device 110 may be shared dynamically. A virtual machine 312 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 110 through a visual display device 314, such as a computer monitor, which may display one or more graphical user interfaces 316, multi touch interface 320, a pointing device 318, and an image capturing device 334.

The computing device 110 may also include one or more computer storage devices 326, such as a hard-drive, CD-ROM, or other computer readable media, for storing data and computer-readable instructions and/or software that implement exemplary embodiments of the present disclosure (e.g., printability application 112). For example, exemplary storage device 326 can include embodiments of the one or more databases 328 for storing data/information described herein. The databases 328 may be updated manually or automatically at any suitable time to add, delete, and/or update one or more data items in the databases.

The computing device 110 can include a network interface 308 configured to interface via one or more network devices 324 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 322 to facilitate wireless communication (e.g., via the network interface) between the computing device 110 and a network and/or between the computing device 110 and other computing devices. The network interface 308 may include a built-in network adapter, network interface card, PCMCIA network card, card bus network adapter, wireless network adapter, USB network adapter, modem or any other device suitable for interfacing the computing device 110 to any type of network capable of communication and performing the operations described herein.

The computing device 110 may run any operating system 310, such as versions of the Microsoft® Windows® operating systems, Apache HTTP software, different releases of the Unix and Linux operating systems, versions of the MacOS® for Macintosh computers, embedded operating systems, real-time operating systems, open-source operating systems, proprietary operating systems, or any other operating system capable of running on the computing device 110 and performing the operations described herein. In exemplary embodiments, the operating system 310 may be run in native mode or emulated mode. In an exemplary embodiment, the operating system 310 may be run on one or more cloud machine instances.

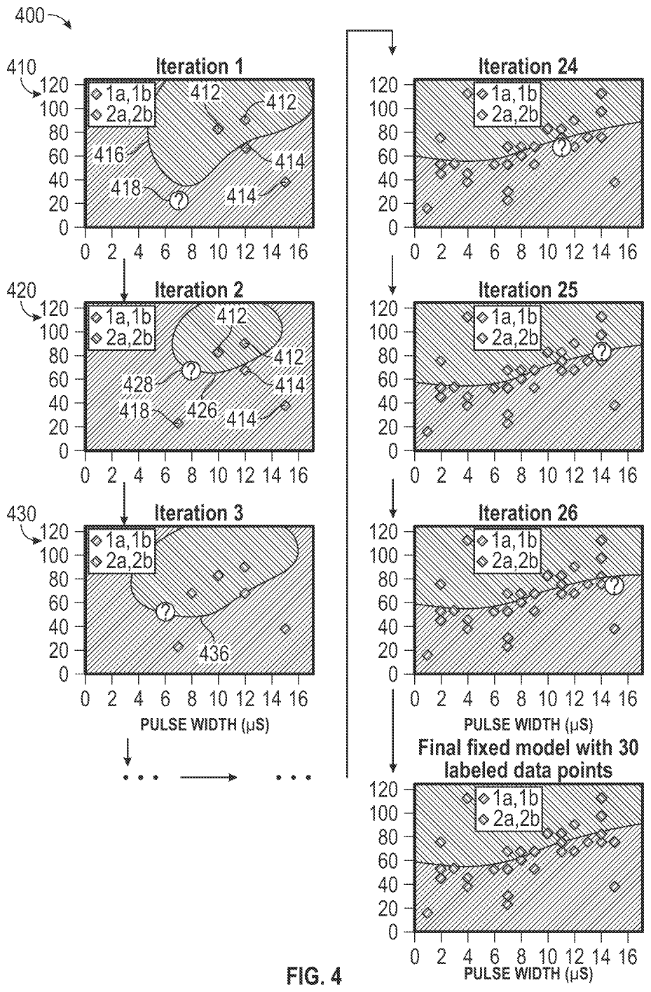

FIG. 4 illustrates an iterative process 400 for defining a decision boundary using the RBF kernel SVM algorithm in accordance with embodiments of the present disclosure. As a non-limiting example, the RBF kernel SVM algorithm shown in FIG. 4 illustrates two controllable features or operating parameters of the print head: a firing voltage applied to the print head (shown on the y-axis) and the pulse width of the applied firing voltage (shown on the x-axis). In a first iteration 410, the RBF kernel SVM algorithm is initialized with an initial small sample of labeled data points 412 and 414. In the present example, the data points 412 correspond to two data points from printing experiments where jetting occurred and the data points 414 correspond to two data points from printing experiments where jetting does not occur. The RBF kernel SVM algorithm generates an initial decision boundary 416 based on the initial sample of labeled data points 412 and 414. The computing device executes the printability application to select a next data point 418 from a pool of unlabeled data points based on the highest uncertainty on the predicted label, i.e., the data point with shortest distance to the current decision boundary. This point is the new query for which a label is to be obtained by conducting a printing experiment. After the data point 418 is labeled based on the jettability/non-jettability captured in an image by the drop watching system, the labeled data point 418 (in this case labeled as non-jettable) is added to the training dataset and the decision boundary 416 is updated to be decision boundary 426.

In a next iteration 420, the computing device 110 executes the printability application to select a next data point 428 from a pool of unlabeled data points based on the highest uncertainty on the predicted label, i.e., the next data point with shortest distance to the current decision boundary 426. This point is the new query for which a label is to be obtained by conducting a printing experiment. After the data point 428 is labeled based on the jettability/non-jettability captured in an image by the drop watcher, the labeled data point 428 (in this case labeled as jetting) is added to the training dataset and the decision boundary 426 is updated to the decision boundary 436 for the next iteration 430. This process 400 continues until a labeling budget is exhausted (i.e., a specified number of unlabeled data points are labeled). In the non-limiting example illustrated in FIG. 4, the process 400 performs twenty-six iterations to reach a labeling budget or thirty which includes the 4 initial labeled data points 412 and 414 and twenty-six newly labeled data points (including data points 418 and 428).

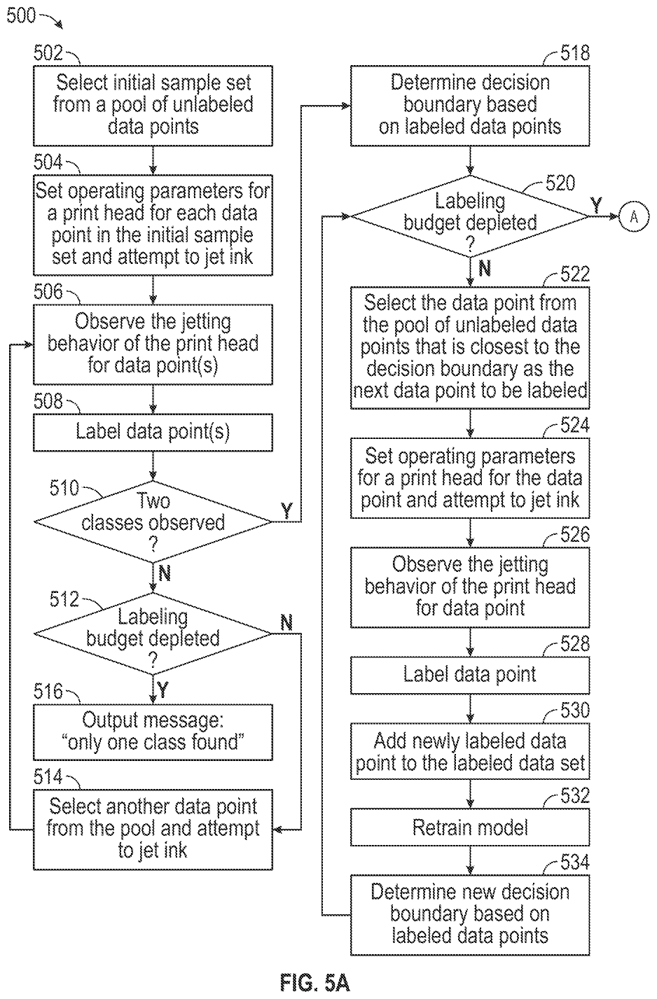

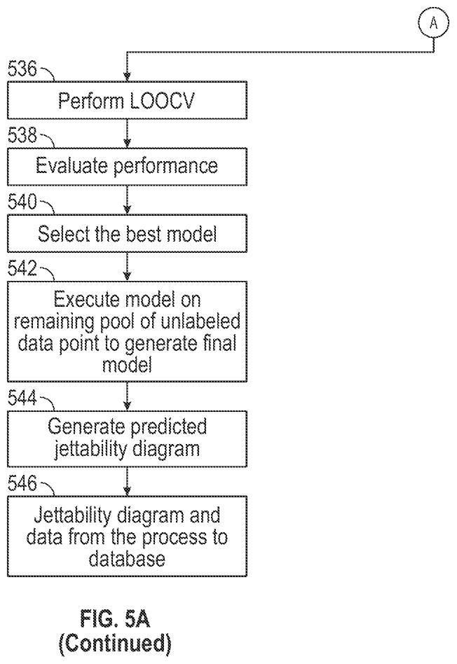

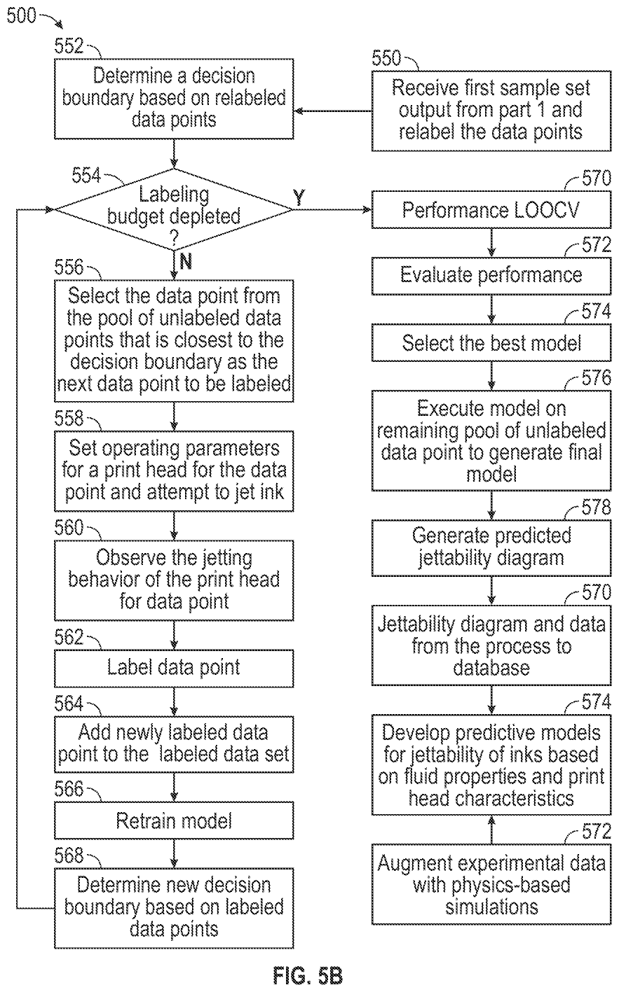

FIGS. 5A-B are flowcharts illustrating a first and second part of an example process 500 of the printability application 112 executed by the computing device 110 to determine a jettability zone for a print head and ink combination using different operating parameters. The process 500 first executes operations to determine a decision boundary between the jetting and no jetting zones, and second executes operations to find a consistent jetting zone from within the defined jetting zone. That is, the overall process is implemented in two parts:
Step 1: prediction of “jetting” vs. “no jetting” zone
   Here “no jetting” zone including no jetting and partial jetting is identified and distinguished from the “jetting” zone that covers consistent jetting and inconsistent jetting.
Step 2: prediction of “consistent jetting” vs. “others” zone
   This step aims to identify consistent “jetting” zone vs. “others” (no/partial/inconsistent jetting).

As shown in FIG. 5A, Step 1 of the process 500 is executed by the processor(s) of computing device 110 as a fully automated closed loop without human intervention. At operation, 502, the process 500 is executed by the processor(s) of computing device 110 to select an initial sample set for a set of unlabeled data points. As a non-limiting example, the process 500 can be executed to randomly select four data points to start Step 1 of the process 500. The settings/values of two or more of the operating parameters of the print head can be set to the values in each of the data points in the initial sample set and the print head can attempt to jet the ink for each of the data points at operation 504. At operation 506, the jetting behavior of the print head-ink combination is observed for each of the data points. For example, the imaging device of the drop watcher can image the nozzles of the print head or a medium upon which the ink is deposited if jetting occurs. The labels for the initial sample set are determined at operation 508, e.g., based on an output of one or more machine vision algorithms or techniques processing the images captured by the drop watcher. At operation 510, the processor(s) of the computing device executes the process to determine whether there are two classes of labels.

If the labeled data points from the initial sample set does not include two classes, Step 1 of the process 500 continue to operation 512, at which the processor(s) of the computing device executes the process 500 to determine if remaining labeling budget is available. If the first labeling budget has not been depleted, the process 500 continues at operation 514 to sample and label another data point, after which Step 1 of the process 500 returns to operation 506 to observe the jetting behavior, proceeds to operation 508 to label the data point, and then to operation 510 to determine whether the labeled data points include two classes. If two classes have not been identified, Step 1 of the process 500 continues to iteratively determine whether the labeling budget has been depleted (operation 512), and if not, to label another data point (operation 514) until either the labeled data points include the two classes (operation 510) or until the labeling budget has been depleted (operation 512). If the labeling budget has been depleted without observing two class within the labeled data points, the process 500 returns a message to the user at operation 516 indicating that only one class was found. As an example, if the labeling budget is thirty (30), i.e., there is a budget to find the label for thirty (30) data points out of a number of data points. To start, two data points are sampled and labeled. If the two selected data points are both classified as no-jetting, Step 1 of the process 500 continues sampling and labeling. If after using all of the thirty (30) data points, all of the data points have been labeled as “no jetting” the process return this message: only Class 0, “no jetting” zone, was found.

Once the labeled data points from Step 1 of the process 500 includes the two classes: “no jetting” and “jetting” (operation 512), the RBF kernel SVM model of the printability application 112 is implemented on the two-class labeled sample data points to find an initial decision boundary between “jetting” and “no jetting” at operation 518. At operation 520, the computing device 110 executing the process 500 determines whether a first active learning labeling budget has been depleted for Step 1 of the process 500. If not, Step 1 of the process proceeds to operation 522, at which the printability application finds, among the pool of unlabeled data points, the closest data point to the decision boundary as a new data point for which a label is to be determined. The settings/values of two or more of the operating parameters of the print head can be set to the values in each of the data point and the print head can attempt to jet the ink for each of the data points at operation 526. At operation 526, the jetting behavior of the print head-ink combination is observed for the next data point. For example, the imaging device of the drop watcher can image the nozzles of the print head or a medium upon which the ink is deposited if jetting occurs. The labels for the initial sample set are determined at operation 528, e.g., based on an output of one or more machine vision algorithms or techniques processing the images captured by the drop watcher.

At operation 530, the newly labeled data point is added to the labeled data, and at operation 532, the RBF kernel SVM model is retrained using the updated labeled data to find a new trained model, and at operation 534, a new decision boundary is determined. Step 1 of the process 500 then returns to operation 520 to determine if the first active learning labeling budget has been depleted. If not, Step 1 of the process 500 continues in a loop defined by operations 520-534 until the first active learning labeling budget is depleted. After it is determined that the first active learning labeling budget is depleted at operation 524, Step 1 of the process 500 has generated a classification model implemented on the labeled data. At operation 536, after the labeling budget has been depleted, models for a range of regularization parameters, C, and gamma parameters, γ, are implemented on the data and their performances are compared using LOOCV or k-fold cross validation for a specified value of k. As an example, the performance of each generated model can be evaluated using accuracy on 10-fold cross validation. At operation 538, the model with the highest performance is selected. The best performing model is determined to be the model with the highest accuracy. At operation 540, the selected model re-trained on all labeled data using optimal regularization parameter, C, and gamma parameter, γ, of the selected model. At operation 542, the selected model is executed to predict labels of remaining pool of unlabeled data to generate a final model. At operation 544, a report can be output by Step 1 of the process that shows “no jetting” vs. “jetting” zone, e.g., as a jettability diagram, and at operation 546 the jettability diagrams and data associated with the experiments of the process 500 can be added to a database (e.g., database 328).

Step 2 of the process 500 begins as shown in FIG. 5B. Step 2 of the process 500 identifies a consistent jetting zone from others. The “others” zone contains no jetting, partial jetting, and inconsistent jetting. At operation 550, Step 2 of the process 500 receives the labeled data set from Step 1 of the process 500, but the data points get reclassified to reflect Class 0 as “others” and Class 1 as “consistent jetting”. With two classes, active learning (with RBF SVM using default parameters) starts to get new query for labeling. The final step is checking the performance of the range of models on all labeled data and return the best performing one for consistent jetting zone prediction.

In Step 2 of the process 500, the RBF kernel SVM model of the printability application 112 is implemented on the two-class labeled data set sampled from Step 1 to find an initial decision boundary between “consistent jetting” and “others” at operation 552. At operation 554, the computing device 110 executing the process 500 determines whether the second active learning labeling budget has been depleted for Step 2 of the process 500. If not, Step 2 of the process proceeds to operation 556, at which the RBF kernel SVM model finds, among the pool of unlabeled data points, the closest data point to the decision boundary as a new data point for which a label is to be determined. The settings/values of two or more of the operating parameters of the print head can be set to the values in each of the data points and the print head can attempt to jet the ink for each of the data points at operation 558. At operation 560, the jetting behavior of the print head-ink combination is observed for the next data point. For example, the imaging device of the drop watcher can image the nozzles of the print head or a medium upon which the ink is deposited if jetting occurs. The labels for the initial sample set are determined at operation 562, e.g., based on an output of one or more machine vision algorithms or techniques processing the images captured by the drop watcher.

At operation 564, the newly labeled data point is added to the labeled data, and at operation 566, the RBF kernel SVM model is retrained using the updated labeled data to find a new trained model, and at operation 568, a new decision boundary is determined. Step 2 of the process 500 then returns to operation 554 to determine if the second active learning labeling budget has been depleted. If not, Step 2 of the process 500 continues in a loop defined by operations 556-568 until the second active learning labeling budget is depleted. After it is determined that the second active learning labeling budget is depleted at operation 554, Step 2 of the process 500 has generated a range of models implemented on the labeled data. At operation 570, after the second active labeling budget has been depleted, models for a range of regularization parameters, C, and gamma parameters, γ, are evaluated using LOOCV or k-fold cross validation for a specified value of k. As an example, the performance of each generated model can be evaluated using accuracy on 10-fold cross validation. At operation 572, the model with the highest performance is selected. The best performing model is determined to be the model with the highest accuracy. At operation 574, the selected model is re-trained on all labeled data using optimal regularization parameter, C, and gamma parameter, γ, of the selected model. At operation 576, the selected model is executed to predict labels of remaining pool of unlabeled data to generate a final model. At operation 578, a report can be output by Step 2 of the process that shows “consistent jetting” versus “others” zones, e.g., as a jettability diagram, and at operation 570 the jettability diagrams and data associated with the experiments of the process 500 can be added to a database (e.g., database 328). The operations of the process 500 can be repeated for new inks and print heads and the output of the process 500 for the ink and print head combinations can be added to the database. At operation 572, the outputs of the jettability diagrams in the database can be augmented by additional information (e.g., features and constraints) from physics-based simulations, and at operation 574, the computing device can execute the printability application to predict jettability of different ink and print head combinations based on measured fluid properties and learned print head characteristics, utilizing the database described herein. In some embodiments, jettability data can be made available to third parties via the database or can be maintained as proprietary.

The images of jetted/non-jetted ink, data/properties for the ink, data about the print heads used for jetting the ink captured in the images, the operating parameters of the print heads, the classification or labels assigned to the ink-print head combinations at different operating parameters, trained machine learning models (e.g., RBF kernel SVM models) and their parameters (e.g., the regularization parameter, C, and the gamma parameter, γ), information from physics-based simulations, fluid properties, and/or the outputs of the printability application 112 in Step 1 and Step 2, including jettability diagrams can be stored in one or more databases (e.g., database(s) 328). The data/information stored in the database(s) 328 can be used to build a corpus of data that can be used to further train and/or deploy machine learning models to predict printability of different ink and print head combinations (e.g., as provided by operation 574), provide print head manufacturers with data/information that can be used to develop or modify print head designs based on different ink materials or compositions to improve jettability different ink materials or compositions, and/or provide ink manufacturers with data/information that can be used to develop or modify ink materials or compositions to improve jettability from one or more print heads.

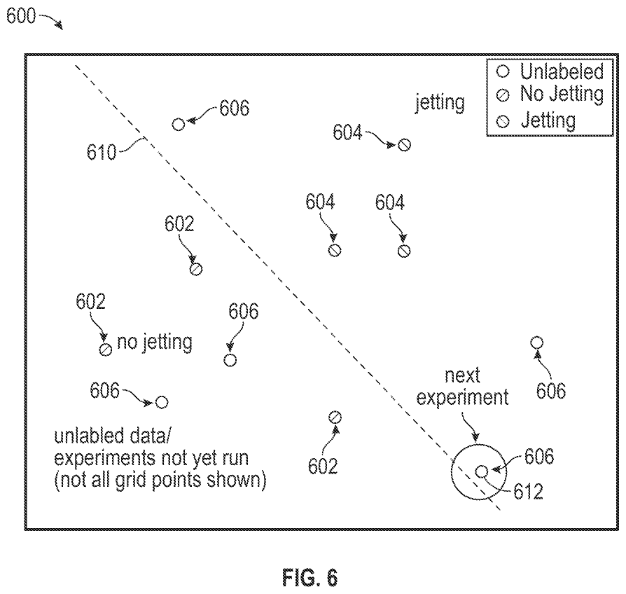

FIG. 6 is a graph 600 that illustrates an example of the process of selecting an unlabeled data point to be labeled during the active learning process which iteratively and autonomously determines the decision boundary of an RBF kernel SVM model of the printability application. As shown in FIG. 6, there are data points 602 previously labeled as “no jetting”, data points 604 previously labeled as “jetting”, and data points 606 which remain unlabeled. A decision boundary 610 is illustrated as a dashed line. To choose the next unlabeled data point to label, the printability application is executed by the computing device to select the unlabeled data point 612 because it is the data point closest to the hyperplane 610 as compared to the remainder of the unlabeled data points 606.

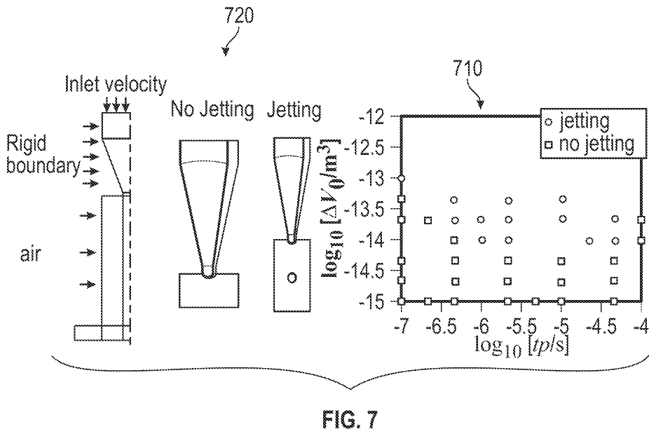

FIG. 7 illustrates an example for generating a predicted jettability diagram 710 based on physical simulations 720 using finite element modeling with a level-set method, where Ao is volume change induced by piezoelectric transducer and tp is the pulse width.

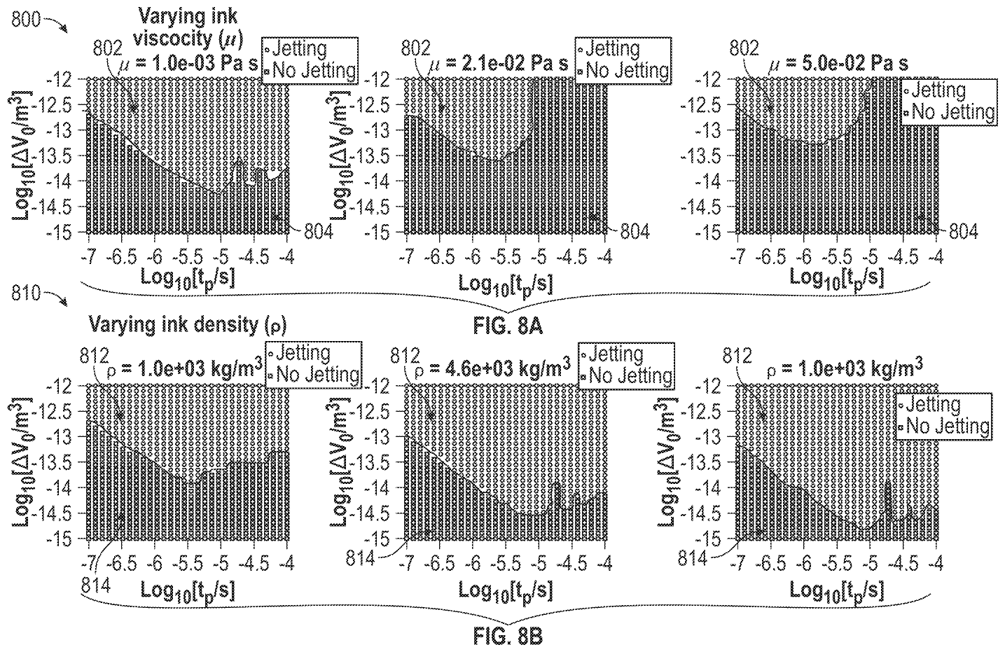

FIGS. 8A-D illustrate example data points in a jettability diagrams as a function of fluid properties based on theoretical calculations corresponding to operation 572 in FIG. 5B. The jettability diagrams include an x-axis which is logarithmic function of a pulse width for the print head and a y-axis which is a logarithmic function of the volume change induced by the piezoelectric transducer. FIG. 8A illustrates jettability diagrams 800 with “jetting” zones 802 and “no jetting” zones 804 for fluids with varying viscosity. FIG. 8B illustrates jettability diagrams 810 with “jetting” zones 812 and “no jetting” zones 814 for fluids with varying densities. FIG. 8C illustrates jettability diagrams 820 with “jetting” zones 822 and “no jetting” zones 824 for fluids with varying surface tension. FIG. 8D illustrates jettability diagrams 830 with “jetting” zones 832 and “no jetting” zones 834 for fluids varying surface the speed of sound via the fluid. In each case, the fluid properties that were not varied were assumed to be: μ=0.005 Pa s, ρ=1000 kg/m³, σ=30 mN/m, c=1182 m/s. ΔV₀: volume change induced by piezoelectric transducer; tₚ: pulse width. Machine learning algorithms may be used to learn a mapping from fluid parameters (e.g., viscosity, elasticity, density, and surface tension, speed of sound) to jettability diagrams and vice versa. For example, training data consisting of sets of jettability diagrams and the corresponding fluid parameters of the inks that were used to produce those jettability diagrams can be used to train a regression model, using methods including but not limited to convolutional neural networks, that predicts fluid parameters from jettability diagrams. Conversely, generative models such as generative adversarial networks, including but not limited to bidirectional conditional generative adversarial networks (Jaiswal, A., AbdAlmageed, W., Wu, Y., Natarajan, P. (2019). Bidirectional Conditional Generative Adversarial Networks. In: Jawahar, C., Li, H., Mori, G., Schindler, K. (eds) Computer Vision—ACCV 2018. ACCV 2018. Lecture Notes in Computer Science, vol 11363. Springer, Cham. doi.org/10.1007/978-3-030-20893-6_14), and convolutional variational autoencoders, can be trained to generate valid jettability diagrams from sets of fluid parameters.

Experiments using an embodiment of the printability application described herein were carried out on two different fluids, as model inkjet inks, namely, deionized water and an inkjet model fluid (XL30, blue, Dimatix, Fujifilm). The deionized water was selected to represent fluids with high surface tension and low viscosity, whereas the blue model fluid was chosen to represent fluids with lower surface tension and higher viscosity that are close to the recommended values for the inkjet printing (Hutchings & Martin, 2013). The surface tension and viscosity of these fluids were measured using a pendant drop tensiometer (DataPhysics) and AR-G2 rheometer (TA Instruments) equipped with a Couette fixture, while the density was measured by weighing a known volume of the model inks.

The printing behavior was classified based on printing process parameters (pulse width and firing voltage) in two binary classification steps in sequence. First, a decision boundary between “jetting” and “no jetting” zones was determined using active learning, as described herein with respect to the Step 1 of the printability application, to reduce the number of experiments required. Then, based on the labeled data, another round of active learning, as described herein with respect to the Step 2 of the printability application, was implemented to find the “consistent jetting” zone. The results obtained from active learning were compared to a grid search method, which involves running more than 200 experiments for each fluid, to assess the performance of the proposed scheme. The active learning method has significantly reduced the number of experiments by 80% while achieving a precision of more than 95% in jettable zone prediction in both fluids.

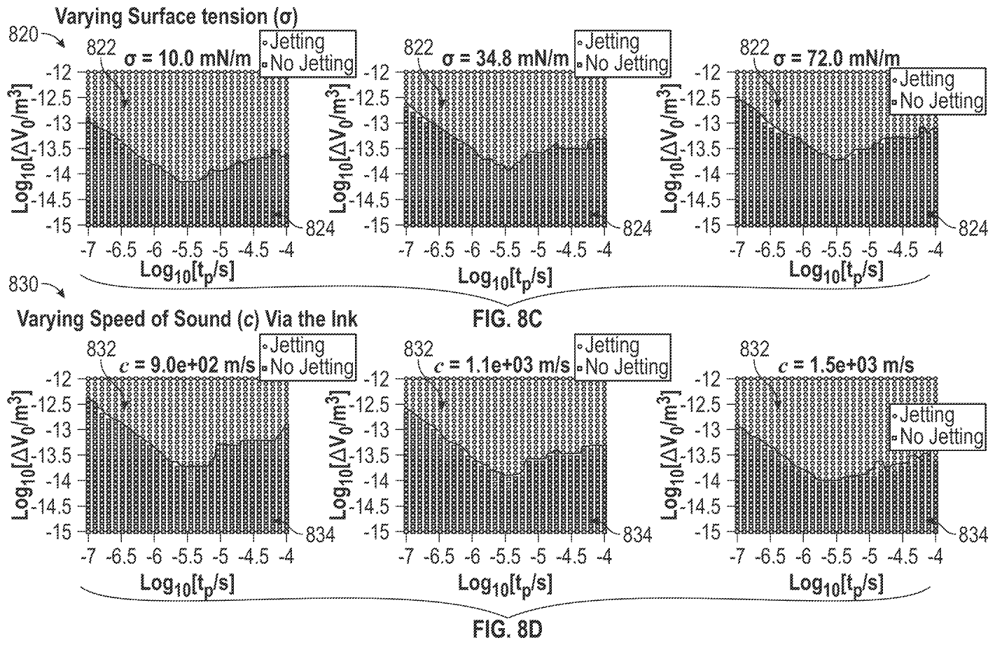

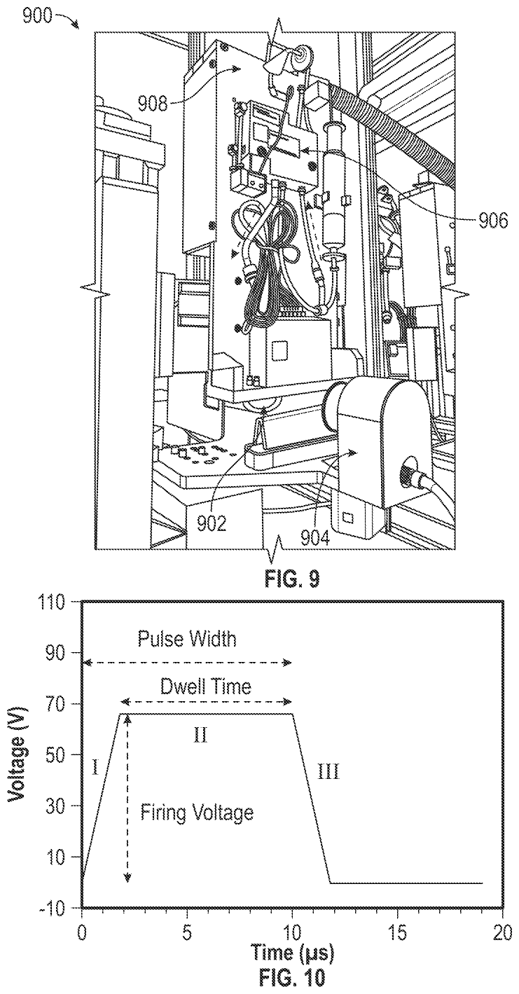

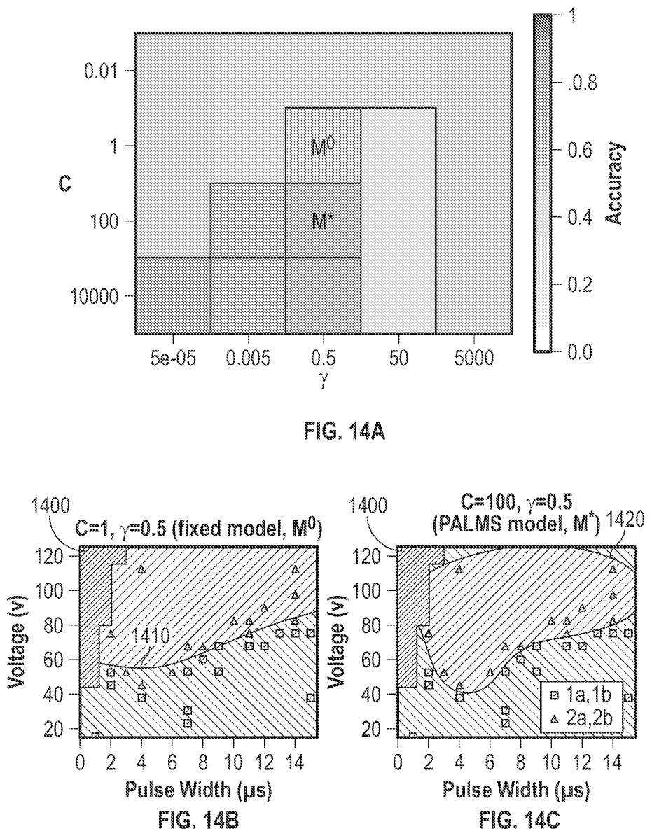

The jetting behavior of the chosen inks were studied using a custom-built “HuskyJet” inkjet printer (S.-Y. Chang, J. Jin, J. Yan, X. Dong, B. Chaudhuri, K. Nagapudi, A. W. K. Ma, Development of a pilot-scale HuskyJet binder jet 3D printer for additive manufacturing of pharmaceutical tablets, Inter. J. Pharm., 605 (2021), 120791, doi.org/10.1016/j.ijpharm.2021.120791) equipped with three piezoelectric inkjet print heads (StarFire SG1024/MA, Dimatix, Fujifilm). Each print head has 1,024 nozzles with a nozzle diameter of 40 μm. During the drop watching experiments, one of the print head assemblies is removed from the processing line and mounted onto the drop watcher system (JetXpert) as shown in FIG. 9. As shown in FIG. 9, the drop watcher setup 900 for imaging the jetting liquid includes a print head under test 902, a camera (imaging device) 904, a circulating ink reservoir 906, and a meniscus line 908. The ink is first loaded with a syringe into the reservoir and then circulated between the reservoir and print head (dashed arrows). Deionized water was filtered (0.22 μm; polyethersulfone (PES) membrane) and degassed by maintaining a low vacuum (30 in. Hg) for 1 h before use. The print head is loaded with the model inks through a syringe equipped with a 5-μm Nylon membrane filter. A slight negative pressure (ca. 0.47 psi) was maintained to prevent the ink from dripping out of the nozzles uncontrollably due to gravity. For piezoelectric print heads, the jetting was controlled by sending an electrical signal, or waveform, to the print head via drive electronics. The jetting waveform is controlled using drive electronics software MetWave and MetPrint (Meteor Inkjet Ltd.). These software programs allow the user to specify and control parameters such as the firing voltage, pulse width, jetting frequency, print head temperature, and rise and fall rates. A typical single-pulse waveform is shown schematically in FIG. 10. In an exemplary experiment, only firing voltage and pulse width were varied to reduce the feature space, while the frequency and temperature were kept at 5000 Hz and 35° C., respectively. For evaluating the model accuracy for predicting data that the model has not been trained on, the true jettability diagrams were collected by varying the firing voltage from 15 V to 120 V with an interval of 5 V and the pulse width from 1 μs to 15 μs with a 1-μs interval. Certain combinations of firing voltage and pulse width are prohibited as the firing voltage will not reach the target value within the pulse width specified (see shaded areas 1400 in FIG. 14B and 14C).

The training data consists of the two features, pulse width and firing voltage, and corresponding labels (Type 1a and 1b vs. Type 2a and 2b defined below for Step 1 of the printability application and Type 2a vs. Type 1a, 1b, and 2b defined below for Step 2 of the printability application). In traditional supervised learning, a training dataset consisting of data points sampled IID (independently identically distributed) from the population would first be obtained. In exemplary experiments, the grid of feasible pulse width and firing voltage combinations are sampled IID.

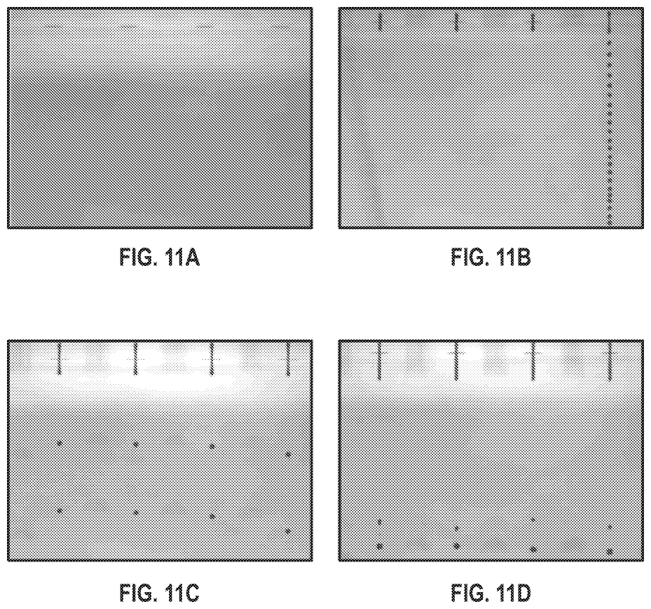

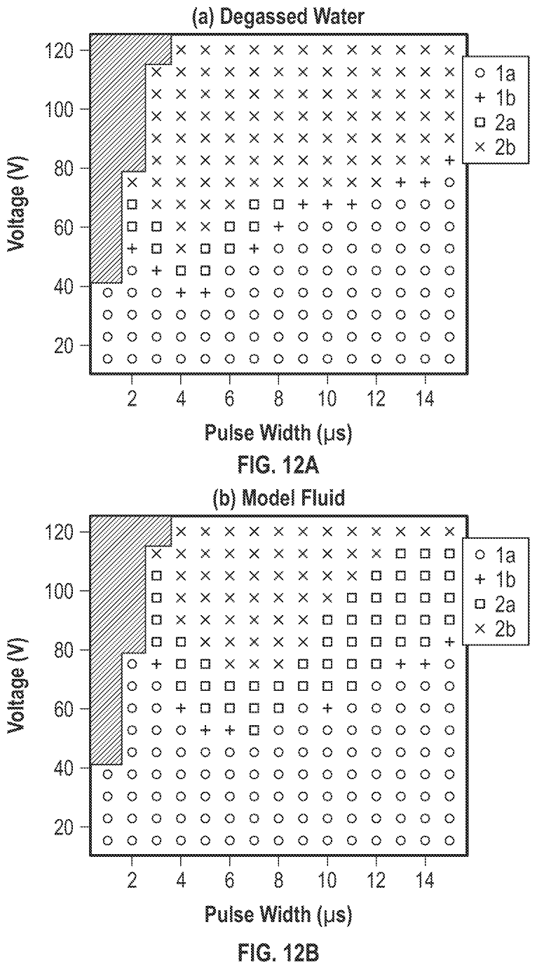

FIG. 11A-D show some representative images collected using the drop watching system. FIG. 11A illustrates no jetting (Type 1a). FIG. 11B illustrates partial jetting (Type 1b). FIG. 11C illustrates primary drop only/consistent jetting (Type 2a). FIG. 11D illustrates satellite drop formation/inconsistent jetting (Type 2b). For a given combination of firing voltage and pulse width, three to four nozzles were arbitrarily sampled. If no droplets or jets are detected in the image, then the jetting behavior is classified experimentally as no jetting (Type 1a). Conversely, if drops or jets are observed, the corresponding data point in the jettability diagram will be labeled as “jetting”. The print head has a total of 1,024 nozzles, and only a few nozzles are imaged per experimental run as the field of view is limited and the imaging magnification must be sufficiently high to resolve individual droplets (if any). There are certain cases in which some nozzles are jetting and some are not. This is classified as partial jetting (Type 1b), commonly observed between the “jetting” and “no jetting” zones. Both no jetting (Type 1a) and partial jetting (Type 1b) are undesirable, so they are grouped into Class 0 as “no jetting” during the first binary classification step. The “jetting” zone (Class 1) is further divided into two sub-classes, namely primary drop only/consistent jetting (Type 2a) and satellite drop formation/inconsistent jetting (Type 2b). Some representative images of these classes are shown in FIGS. 11A-D. Based on this classification method, the jetting behavior observed at different firing voltages and pulse widths was labeled for degassed water and model fluid as shown in FIGS. 12A and 12B, respectively. The experimental results are discussed herein.

The jettability diagrams shown in FIGS. 12A and 12B are generated based on a grid search approach with more than 200 experiments for degassed water (FIG. 12A) and the model fluid (FIG. 12B). The dimensionless viscosity, or Ohnesorge (Oh) number, was calculated to be 0.014 and 0.33 for degassed water and model fluid, respectively. Based on existing literature, satellite drops tend to form for inks with Oh<0.1, whereas the ink may be too viscous to be jetted when Oh>1. While these thresholds are helpful in screening ink formulations, they are empirical and do not explicitly account for the jetting waveform. Other dimensionless groups, such as Weber and Reynolds number, may also be used for understanding the jetting behavior, but drop velocity must be measured and these numbers are not defined in the case of no jetting. The consistent jetting zone with primary drop only (Type 2a) takes on a V or U shape, although the size of the zone and the exact location varies for the two fluids. For a given pulse width, as the firing voltage increases, the jetting behavior generally goes from Type 1a (no jetting) to Type 2a (primary drop only) and then to Type 2b (satellite drop). Partial jetting (Type 1b) is sometimes observed as jetting behavior transitions from Type 1a to Type 2a. The overall transition could be understood in terms of the amount of energy imposed on the ink by the piezoelectric elements. For jetting to occur, the actuation energy must be sufficiently high to overcome the surface and viscous forces and any meniscus pressure that is applied to prevent the ink from dripping out of the nozzle due to gravity. The higher the firing voltage, the higher the energy. At exceedingly low voltage, there is insufficient energy to result in jetting and Type 1a behavior is therefore expected. Conversely, if too much energy is applied, Plateau-Rayleigh instability sets in, resulting in the formation of satellite drops.

The creation and use of jettability diagrams is novel, and as a result, no jettability diagrams are currently available in the literature for direct comparison. However, the existence of pulse widths that reduce the firing voltage required for jetting is consistent with the optimal pulse width concept and drop velocity results reported by (K.-S. Kwon, Experimental analysis of waveform effects on satellite and ligament behavior via in situ measurement of the drop-on-demand drop formation curve and the instantaneous jetting speed curve. J. Micromech. Microeng., 20, (2010) 115005, doi: 10.1088/0960-1317/20/11/115005; H. J. Lin, H. C. Wu, T. R. Shan, W. S. Hwang, The effects of operating parameters on micro-droplet formation in a piezoelectric inkjet printhead using a double pulse voltage pattern, Mater. Trans., 47, (2006), 375-382. doi.org/10.2320/matertrans.47.375). In these studies, for a fixed firing voltage, there exist certain pulse widths where the drop velocity is maximum. In one example, the firing voltage required for jetting is reduced as the pulse width is maintained at ca. 5 μs and ca. 8 μs for degassed water (FIG. 12A) and the model fluid (FIG. 12B), respectively. Fundamentally, the dependence of jetting behavior on pulse width depends on the generation, propagation, and reflection of acoustic pressure waves generated by the piezoelectric transducers. The acoustics within a print head based on a piezoelectric transducer tube have been studied experimentally and theoretically (Alamán et al., 2016; Lin et al., 2006). Briefly, as firing voltage increases (Stage I in FIG. 10), the inner cavity of the tube either expands or contracts depending on the polarization of the piezoelectric transducer. Regardless, the local pressure changes, which further leads to two pressure waves carrying the same sign, traveling in opposite directions, towards the ink supply end and nozzle, respectively. During Stage II (FIG. 10), commonly referred to as the “dwell time”, these pressure waves propagate and are subsequently reflected at the supply end and nozzle. If an open-ended boundary condition is assumed at the supply end with a larger diameter, the sign of the reflected pressure wave will flip. Conversely, if a closed-ended boundary condition is assumed at the nozzle because of its smaller diameter than the squeeze tube, the sign of pressure wave remains unchanged. If the firing voltage decreases (Stage III in FIG. 10) at the optimal dwell time, the newly generated waves will cancel the pressure wave returning from the nozzle but amplify the reflected pressure wave traveling from the supply end towards the nozzle. Jetting will occur if the amplitude of the amplified pressure wave is sufficiently large. In the simplest case of a single nozzle print head, the optimal dwell time or pulse width is equal to the cavity length divided by the speed of sound through the ink. However, in practice, the actual optimal pulse width also depends on the internal geometry of the print head, attenuation of pressure waves due to viscosity and jetting, possible residual pressure from previous pulses, and potential crosstalk between neighboring print nozzles (Alamán et al., 2016; Dijksman, J. Frits, ed. Design of Piezo Inkjet Print Heads: From Acoustics to Applications. John Wiley & Sons, 2019).

A goal of embodiments of the present disclosure is to use as few experiments as possible to learn a model for the jettability diagram as a function of pulse width and firing voltage. In order to build an initial model for active learning, the initial sample needs data points from both classes. In Step 1, “jetting” vs. “no jetting” zone prediction, the process 500 shown in FIG. 5 is initialized with 4 data points, two points each from the “jetting” and “no jetting” classes. To achieve this in the experiments, prior knowledge of jettability diagrams, that the lower and upper bounds of firing voltage typically correspond to “no jetting” and “jetting” conditions, respectively, were utilized. In practice, if this is unsuccessful, random sampling continues until data points from each class are found. The final learned model may differ depending on the initial sample of data points. Given this potential variability, 50 different randomly initialized runs of the process 500 shown in FIG. 5 are implemented and the average performance over these runs is reported.

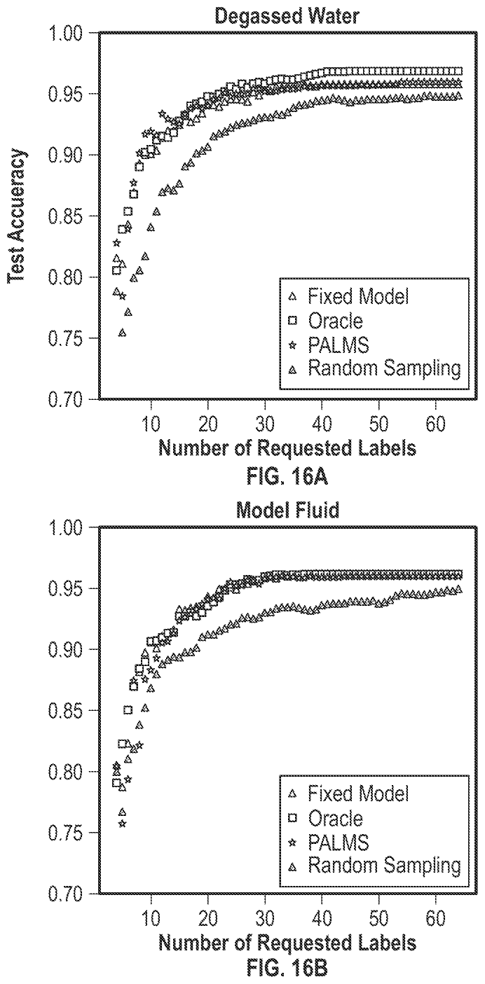

The performance of the process 500 shown in FIG. 5 is compared against two other available methods: fixed model and Random Sampling (FIG. 16). Fixed model does not consider model selection as the final step to choose the best performing model. The fixed model uses an RBF kernel SVM with default parameters C=1, γ=0.5. Random Sampling is based on randomly sampling an IID dataset from unlabeled pool data to train the RBF kernel SVM model; it does not use active learning. However, the final model is chosen in the usual manner for model selection using LOOCV. Finally, these models are compared with an Oracle model, which is defined as the best model selected from the 20 possible models on which active learning is then applied.

In evaluating the performance of the various methods, the definitions of true and false positives, and true and false negatives are defined in the context of the problem.
TP: true positive, original label Class 1 and predicted to be Class 1
TN: true negative, original label is Class 0 and predicted to be Class 0
FP: false positive, original label is Class 0 and predicted to be Class 1
FN: false negative, original label is Class 1 and predicted to be Class 0

In Step 1 for defining “jetting” versus “no jetting”, Class 0 is “no jetting” (Type 1a and 1b) and Class 1 is “jetting” (Type 2a and 2b). In Step 2 for defining “consistent jetting” versus “others”, Class 0 is “others” (Type 1a, 1b, and 2b) and Class 1 is “consistent jetting” (Type 2a) as shown in FIGS. 11A-D.

To demonstrate the efficacy of the printability application described herein, for each material a full grid of pulse width and firing voltages is first experimentally sampled to form a jettability diagram as described herein. In practice, such a dataset would not be available; and it is used here to evaluate the performance of printability application and to demonstrate the advantage of using active learning with model selection in the printability application to efficiently generate an accurate jettability diagram. From the full grid of experimental data points, a set of 100 randomly selected data points is first set aside as test data. After selecting test data, and setting aside an initial sample, the remaining points are considered to be an unlabeled pool data for the experiments.

Performance metrics such as accuracy, confusion matrix and F₁ score were considered to evaluate the performance. To demonstrate the efficacy printability application, the average and standard deviation of performance results over the fifty randomly initialized experiments are reported.
Accuracy:
   For a binary classification problem, accuracy is given by the ratio of the number of correctly predicted data points: data points to the total number of predicted

$$( TP + TN ) / ( TP + TN + FP + FN ) .$$

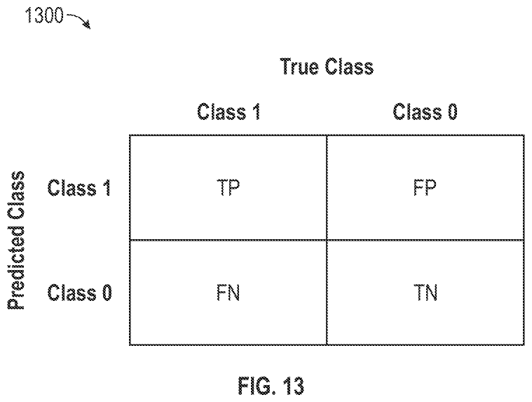

Confusion matrix:
   Confusion matrix returns a table 1300 shown in FIG. 13 with TP, TN, FP, and FN.

The confusion matrix provides a more detailed breakdown of the quality of prediction for each class in binary classification and is especially useful when the number of data points in each class is imbalanced.
F₁ score
   F₁ score (also known as F-measure) is another performance metric for binary classification that provides a single quantitative measurement combining information about precision and recall. For a given class, precision measures the proportion of data predicted to be in that class that are truly from that class: TP/(TP+FP). Recall, on the other hand, measures the proportion of data truly in that class that are predicted to be in the class: TP/(TP+FN). The F₁ score is the harmonic mean of precision and recall, giving equal importance to the two:

$${F}_{1} = \frac{2}{\frac{1}{recall} + \frac{1}{precision}} = \frac{TP}{TP + 0.5 ( FP + FN )}$$

Accuracy is used to evaluate the performance after Step 1 of the printability application is executed, and confusion matrix and F₁ score are used to evaluate the performance after Step 2 of the printability application, since in Step 2 the classes are very imbalanced.

The performance of one of the 50 cases for Step 1 of the printability application is illustrated in FIG. 14A-C. FIG. 14A shows a validation accuracy heat map in model selection process (using different C and γ hyperparameters in RBF kernel SVM in Step 1) for degassed water. FIG. 14B shows a decision boundary or hyperplane 1410 using fixed model (M⁰) as the final best model. FIG. 14C shows a decision boundary 1420 using a model (M*) derived via the printability application as the final best model. Shown in FIG. 14A, selected by printability application, final best model (M*) has higher accuracy compared to fixed model (M⁰, C=1 and γ=0.5). Decision boundaries from these two models (M⁰ and M*) on the same actively labeled data are shown in FIG. 14B and FIG. 14C. In this case, PALMS selected a model with larger C (C=100) compared to fixed model which led to M* with more accurate decision boundary.

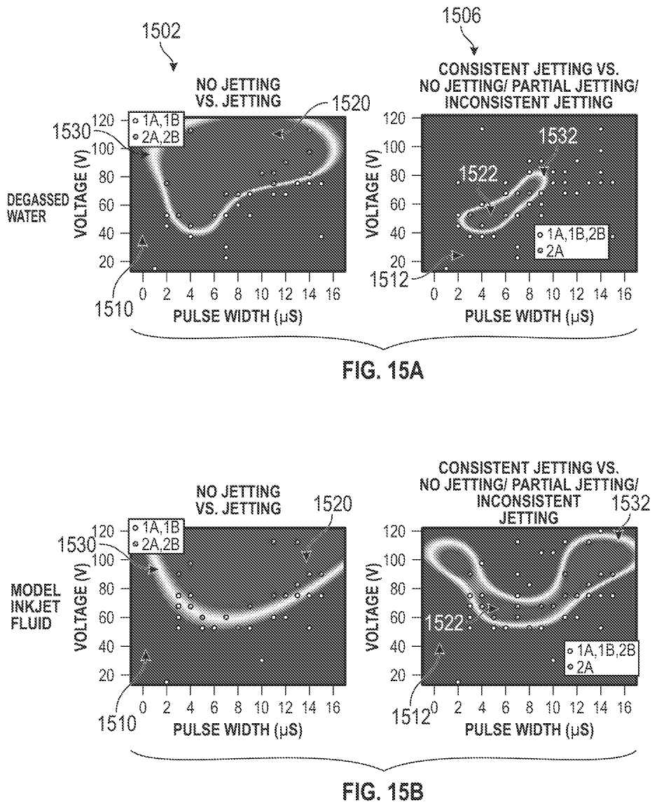

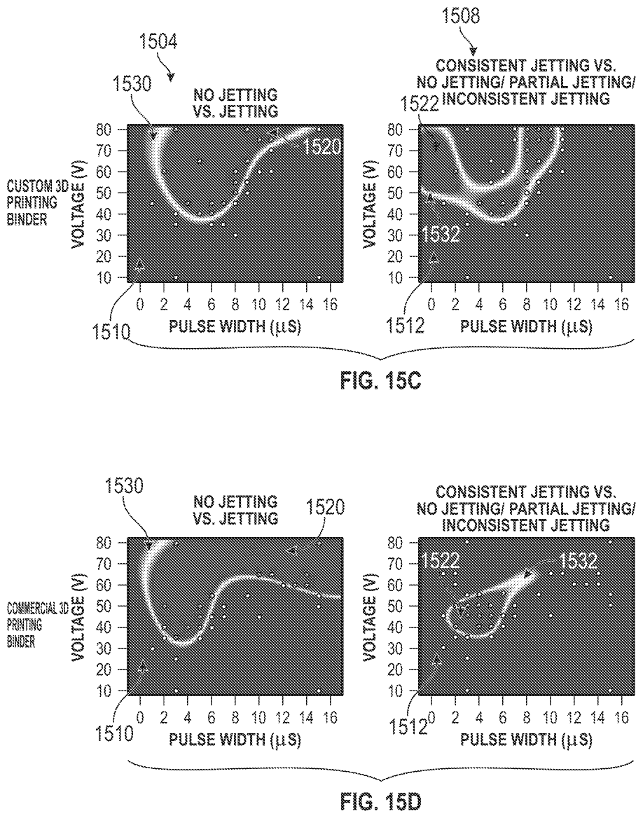

FIG. 15A-D show the final model in Step 1 for one of the 50 cases using different fluids. FIG. 15A is a predicted jettability diagram for degassed water. FIG. 15B is a predicted jettability diagram for a model inkjet fluid. FIG. 15C is a predicted jettability diagram for a custom-made 3D printing binder. FIG. 15D is a predicted jettability diagram for a commercial 3D printing binder. FIGS. 15A and 15C are the final best models using 30 actively sampled data points on degassed water and a custom-made 3D printing binder, respectively. For plots 1502 (FIG. 15A) and 1504 (FIG. 15C), the predicted model shows a zone 1510 for Types 1a and 1b (“no jetting”) and a zone 1520 for Types 2a and 2b (“jetting”). The area 1530 in plots 1502 and 1504 depicts the highest uncertainty zone between Types 1a and 1b and Types 2a and 2b. For plots 1506 (FIG. 15A) and 1508 (FIG. 15C), the predicted model shows a zone 1512 for Types 1a, 1b, and 2b and a zone 1522 for Type 2a. The white areas 1532 depict the highest uncertainty zone between Types 1a, 1b, and 2b (“others”) and Type 2a (“consistent jetting”). FIG. 15B and 15D show the implementation of final model (M*) for a model inkjet fluid and a commercial 3D printing binder, where the zones are denoted using the same scheme as in FIGS. 15A and 15C.

The accuracy versus number of requested labels for different methods is presented in FIGS. 16A-B. FIGS. 16A-B are the accuracy of the final model on test data for degassed water and model fluid, respectively, where the y-axis is a measure of accuracy and the x-axis is a measure of requested labels. Oracle, fixed model, PALMS implemented by the printability application, and random sampling are shown in FIGS. 16A-B. In all methods, adding more labeled data to train leads to better performance of predicted model and higher accuracy in predicting labels in test data. Considering only four data points are used as the initial sample for all methods, adding more data points significantly affect the decision boundary to better performance and as a result pace to the higher accuracy at the beginning is much faster. However, when enough label data is available the performance of prediction model is barely or not changing. This is seen toward the end of plots in FIGS. 16A-B. Although fixed model and PALMS has shown similar performance in these two datasets, this is typically due to the fixed model already being close to optimal. It is previously discussed that since there is no prior knowledge to the nature of the data, PALMS leads to the same or better results than the fixed model (Pardakhti et al., 2021). It was observed that performance of PALMS in both datasets gets to its highest (more than 95%) using around 30 data points, we decided to use only 30 data points for the labeling budget in Step 1 of the printability application. With a limited budget, this is also important for users to get enough data for the best performance and save some budget for the next step.

The process of predicting a consistent jetting zone (as in Step 2 of the printability application) starts with 30 data points obtained from the process for identifying the “jetting” versus “no jetting” zones, where the 30 data points are considered as the initial sample in the algorithm shown in FIG. 4 to find consistent jetting (Type 2a) zone. Here all other cases such as no jetting, partial jetting and inconsistent jetting (Type 1a, 1b, and 2b) assume to be in one class (Class 0) and the desired class is consistent jetting (Type 2a as Class 1). After relabeling the initial sample (Type 1a, 1b, and 2b is Class 0 and Type 2a is Class 1), active learning starts following the algorithm depicted in FIG. 5B. We used a labeling budget of 10. After getting all the queries, a range of 20 models are trained on labeled data and the best model is selected. Model selection in this example is based on F₁ score. It is important to understand that consistent jetting may have a smaller zone than others. Hence the model selection based on F₁ score is a better choice dealing with imbalanced data. The best model has the highest F₁ score. Later the best model (M⁺) is trained on all labeled data (here 40 data points: 30 from the first part and 10 from second part) and then returned to the user as the final model for consistent jetting zone prediction.

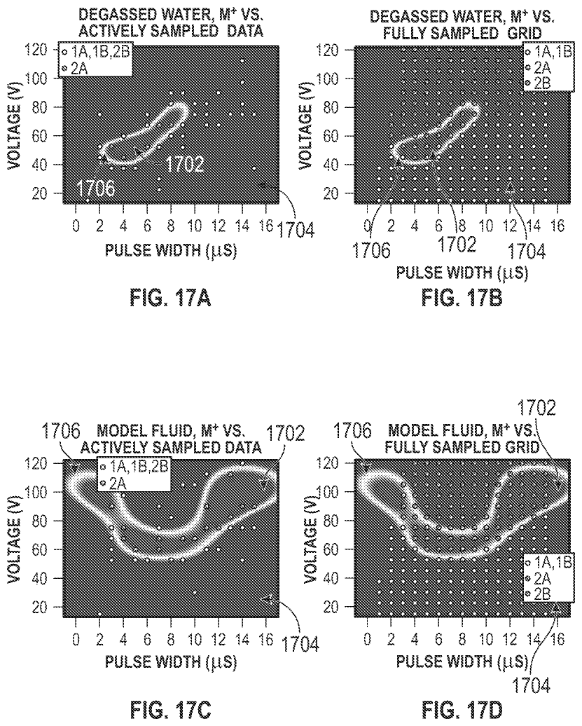

FIGS. 17A and 17C are the M⁺ model using actively labeled samples of degassed and model fluid systems, respectively. The Type 2a predicted zones 1702 and Type 1a, 1b, and 2b predicted zones 1704, while the most uncertain zone 1706 is in white. The reflection of M⁺ models on fully grid data are shown in FIGS. 17B and 17D. FIGS. 17A-D show how well the predicted model captured the consistent jetting zone comparing the real labeled data points (no/partial jetting, inconsistent jetting and consistent jetting). The effort of getting labels for the full grid is simply not practical and the purpose of presenting them in this is just for evaluating embodiments of the present disclosure.

TABLE 1
Performance metrics on test data after Step 1 and Step 2. The lower
F₁ scores after Step 2 reflects the inherently small and difficult
to identify “consistent jetting” regions, while the accuracy
remains relatively high due to class imbalance towards many more
data points with no/partial jetting and inconsistent jetting.

| | TP | FP | TN | FN | F₁ score | Accuracy |
|---|---|---|---|---|---|---|
| Step 1 | | | | | | |
| Degassed water | 49 | 3 | 46 | 3 | 0.94 | 0.95 |
| Model fluid | 46 | 2 | 49 | 3 | 0.95 | 0.96 |
| Step 2 | | | | | | |
| Degassed water | 4 | 4 | 89 | 3 | 0.48 | 0.93 |
| Model fluid | 21 | 8 | 67 | 4 | 0.78 | 0.89 |

1. A method for autonomously predicting jettability of a print head and ink combination in a fully automated loop, the method comprising:
generating, by a processor for a set of default hyperparameter values, a default classification model, the default classification model is generated using an active learning algorithm by iteratively determining a decision boundary predicting a jetting behavior of a print head and ink combination based on training data corresponding to labeled data points until an active learning labeling budget is depleted, the data points corresponding to operating parameter values of the print head;
generating a plurality of new classification models for different sets of hyperparameter values;
evaluating a performance of the default classification model and the plurality of new classification models;
selecting a highest performing classification model from the default classification model or one of the plurality of new classification models corresponding to one of the sets of hyperparameter values based on the evaluated performance;
re-training the selected highest performing classification model using the corresponding one of the sets of hyperparameter values and the set of labeled data points; and
outputting a jettability diagram predicting the jetting behavior of the print head and ink combination for a range of operating parameter values of the print head based on the re-trained selected highest performing classification model.

2. The method of claim 1, wherein the default classification model learned using active learning and the plurality of new classification models are support vector machine models with a radial basis function kernel.

3. The method of claim 2, wherein the hyperparameter values correspond to a regularization parameter and a gamma parameter.

4. The method of claim 1, wherein iteratively determining the decision boundary of the default classification model learned using active learning comprises:
(a) generating the decision boundary based on the training data, the training data including an initial sample set of labeled data;
(b) selecting, autonomously by the processor, a next unlabeled data point from a pool based on a distance of the unlabeled data point from the decision boundary;
(c) setting, by the processor, the operating parameter values corresponding to the next data point;
(d) attempting to jet ink from print head using the operating parameter values;
(e) capturing an image an output of the print head to determine the jetting behavior of print head for the operating parameter values;
(f) using computer vision to automatically classify the next unlabeled data point based on the jetting behavior so that the next unlabeled data point becomes a new labeled data point;
(g) adding the new labeled data point to the training data; and
(h) repeating (a) through (g) until an active learning labeling budget is depleted.

5. The method of claim 4, wherein the initial sample set of labeled data includes labeled data points corresponding to jetting and non-jetting behavior of the print head and ink combination.

6. The method of claim 5, wherein the jettability diagram predicts a jetting behavior of the print head and ink combination as either jetting or non-jetting for the range of operating parameter values.

7. (canceled)

8. (canceled)

9. The method of claim 1, wherein the selected highest performing classification model is augmented by information from physics-based simulations for different ink properties and print head designs.

10. The method of claim 1, wherein the performance of the default classification model and the plurality of new classification models is evaluated using cross-validation.

11. The method of claim 10, wherein the cross validation used is at least one of leave-one-out cross-validation or k-fold cross-validation.

12. A system for autonomously predicting jettability of a print head and ink combination in a fully automated loop, the system comprising:
at least one print head controllable to eject ink;
an imaging device configured to image a jetting behavior of the at least one print head; and
a processor programmed to:
generate, by a processor for a set of hyperparameter values, a default classification model learned using active learning, the default classification model is generated by iteratively determining a decision boundary predicting a jetting behavior of a print head and ink combination based on training data corresponding to labeled data points until an active learning labeling budget is depleted, the data points corresponding to operating parameter values of the print head;
generate a plurality of new classification models for different sets of hyperparameter values;
evaluate a performance of the default classification model and the plurality of new classification models;
select a highest performing classification model from the default classification model or one of the plurality of new classification models corresponding to one of the sets of hyperparameter values based on the evaluated performance;
re-train the selected highest performing classification model using the corresponding one of the sets of hyperparameter values and the set of labeled data points; and
output a jettability diagram predicting the jetting behavior of the at least one print head and ink combination for a range of operating parameter values of the print head based on the re-trained selected highest performing classification model.

13. The system of claim 12, wherein the default classification model learned using active learning and the plurality of new classification models are support vector machine models with a radial basis function kernel.

14. The system of claim 13, wherein the hyperparameter values correspond to a regularization parameter and a gamma parameter.

15. The system of claim 12, wherein the processor is programmed to iteratively determine the decision boundary of the default classification model learned using active learning by:
(a) generating the decision boundary based on the training data, the training data including an initial sample set of labeled data;
(b) selecting, autonomously by the processor, a next unlabeled data point from a pool based on a distance of the unlabeled data point from the decision boundary;
(c) setting, by the processor, the operating parameter values corresponding to the next data point;
(d) attempting to jet ink from print head using the operating parameter values;
(e) capturing, via the imaging device, an image an output of the print head to determine the jetting behavior of print head for the operating parameter values;
(f) using computer vision to automatically classify the next unlabeled data point based on the jetting behavior so that the next unlabeled data point becomes a new labeled data point;
(g) adding the new labeled data point to the training data; and
(h) repeating (a) through (g) until an active learning labeling budget is depleted.

16. The system of claim 15, wherein the initial sample set of labeled data includes labeled data points corresponding to jetting and non-jetting behavior of the print head and ink combination.

17. The system of claim 16, wherein the jettability diagram predicts a jetting behavior of the print head and ink combination as either jetting or non-jetting for the range of operating parameter values.

18. (canceled)

19. (canceled)

20. The system of claim 12, wherein the highest performing classification model is augmented by information from physics-based simulations for different ink properties and print head designs.

21. The system of claim 12, wherein the processor is programmed to evaluate the performance of the default classification model and the plurality of new classification models using cross-validation.

22. The system of claim 21, wherein the cross validation used is at least one of leave-one-out cross-validation or k-fold cross-validation.

23. A non-transitory computer-readable medium comprising instructions that when executed by a processor causes the processor to:
generate, by a processor for a set of hyperparameter values, a default classification model learned using active learning, the default classification model is generated by iteratively determining a decision boundary predicting a jetting behavior of a print head and ink combination based on training data corresponding to labeled data points until an active learning labeling budget is depleted, the data points corresponding to operating parameter values of the print head;
generate a plurality of new classification models for different sets of hyperparameter values;
evaluate a performance of the default classification model and the plurality of new classification models;
select a highest performing model from the default classification model or one of the plurality of new classification models corresponding to one of the sets of hyperparameter values based on the evaluated performance;
re-train the selected highest performing classification model using the corresponding one of the sets of hyperparameter values and the pool of unlabeled data points; and
output a jettability diagram predicting the jetting behavior of the print head and ink combination for a range of operating parameter values of the print head based on the re-trained selected highest performing classification model.

24. The medium of claim 23, wherein the default classification model learned using active learning and the plurality of new classification models are support vector machine models with a radial basis function kernel, the hyperparameter values correspond to a regularization parameter and a gamma parameter, and executing of the instructions by the processor causes the processor to:
(a) generate the decision boundary based on training data, the training data including an initial sample set of labeled data;
(b) select, autonomously by the processor, a next unlabeled data point from the pool based on a distance of the unlabeled data point from the decision boundary;
(c) set, by the processor, the operating parameter values corresponding to the next data point;
(d) attempt to jet ink from print head using the operating parameter values;
(e) capture an image of an output of the print head to determine the jetting behavior of print head and ink combination for the operating parameter values;
(f) using computer vision to automatically classify the next unlabeled data point based on the jetting behavior so that the next unlabeled data point becomes a new labeled data point;
(g) add the new labeled data point to the training data; and
(h) repeat (a) through (g) until an active learning labeling budget is depleted.

25. The medium of claim 23, wherein the performance of the default classification model and the plurality of new classification models is evaluated using cross-validation.

26. The medium of claim 25, wherein the cross validation used is at least one of leave-one-out cross-validation or k-fold cross-validation.
